(19) United States
(12) Patent Application Publication
(10) Pub. No.: US 2007/0100693 A1
(43) Pub. Date: May 3, 2007

(54) Systems and methods for offering real estate promotions to buyers and buyers' agents

(76) Inventors: Robert N. Milman, Winston-Salem, NC (US); Jacob Edward Coby, Belews Creek, NC (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/518,156

(22) Filed: Sep. 11, 2006

Related U.S. Application Data
(60) Provisional application No. 60/716,365, filed on Sep. 12, 2005.

(51) Int. Cl. G06Q 30/00

(52) U.S. Cl. 705/14

(57) ABSTRACT

Systems and methods are disclosed for allowing an agent to create one or more promotions to send to real estate buyers and their agents. In one embodiment, a computer-implemented method of creating a promotion for a real estate service by at least one real estate agent associated with the real estate service is disclosed. The method may comprise method of creating a promotion for a real estate service by at least one real estate agent associated with the real estate service is provided. The method may comprise offering to one or more participants one or more promotions that can be selected by each participant and allowing each participant to select a promotion for a particular property to be promoted. The method may further comprise comparing preselected features of the particular property with information in the real estate data to determine the recipients of the promotion, and sending promotional materials to the recipients determined through the comparing step.

### RELATED APPLICATIONS

This application claims priority to, and incorporates in full by reference, U.S. Provisional Patent Application Ser. No. 60/716,365, entitled “Methods and Systems for Promoting and Marketing Property Listings to Targeted Buyers and/or the Buyer's Real Estate Agents Using a Computer Network Such as the Internet; and/or Interactive, Multi-Dimensional Property Information Web Sites with an Integrated Online Sales Component and Quantifiable Reporting of Results” filed Sep. 12, 2005.

### Field of the Invention

The present invention relates generally to the field of real estate. More particularly, the present invention relates to a method and system for creating real estate promotions for real estate properties, and for the sellers and sellers' agents, via a computerized system, preferably over the Internet.

### BACKGROUND OF THE INVENTION

Conventionally, real estate agents use the multiple listing service (MLS) system to locate properties of interest for their clients and to carry out other real estate services. Agents typically conduct searches for properties using a computer interface terminal associated with the MLS. For example, an agent may specify a particular price range, MLS area, minimum number of bedrooms, and minimum square footage, and the MLS computer system will return a search result of properties in the MLS database fitting those specifications. The agent may print the search results and save the search criteria for future use, if desired, using the MLS system in order to carry out the agent's work. Thus, in this conventional system, the real estate agent pulls information from the MLS database. That is, the agent specifies a desired profile, and information is extracted (or “pulled”) from the MLS database, formatted, and provided to the agent.

In addition to changing the expectations of buyers and sellers of real estate in relation to speed and knowledge, the Internet has given buyers and sellers access to information that previously was available only through a real estate agent. For example, Internet services now allow real estate buyers and sellers to search MLS information by specifying property profiles. Thus, it is increasingly important for real estate agents to provide timelier, value-added services to their clients. It is further beneficial to provide agents and their clients (sellers and buyers) with a system that increases their productivity and success in offering and selling real estate properties.

### SUMMARY OF THE INVENTION

In accordance with the invention, a real estate service is provided that allows participants having assess to the system, preferably real estate agents, to consider, select and generate one or more promotions that in turn are sent to one or more buyers and/or the buyers' agents through the system. The systems and methods of the present invention offer agents and/or their clients a variety of different promotions and preferably provide the participant with some estimate of the number of buyers and/or agents who would receive a promotion, if the promotion were completed and paid for. The promotions, if selected by the agent, preferably allow the agent to include messages or information the agent believes would assist in attracting interest in the property by persons receiving the promotions. The system also in the preferred embodiment automatically includes preferential notices and ordering of listings to maximize the effectiveness of the promotion.

Preferably, the systems and methods of the present invention match the selected promotion to buyers and agents most likely to have an interest in the property being promoted and send the promotion to such matches. This is achieved by comparing a selection made by the requestor with real estate data already in the real estate system. The selection can be, for example, a particular property offered for sale, along with features of that property. More preferably, the system not only sends the promotion to buyers or agents but also tracks any responses of the buyers or buyer agents to the promotions. Information and reports regarding a promotion and the results of the tracked data regarding the promotion are provided to the agent and/or the agent's selling client, during and preferably also after the completion of the promotion. Thus, both during and after the promotion the owner and listing agent of the promoted property, as well as potential buyers and buyer agents, are provided with notices, reminders, information, and/or reports designed to increase the prospects for a sale of the property.

The system and methods of the present invention can be applied to a wide variety of real estate computerized systems that include channels of communication to the participants (e.g. buyers, sellers, and/or agents) of the system. Under the system and methods of the invention, a wide variety of promotions, with specific characteristics and features, can be applied, and the scope of the invention includes sending any promotion to a targeted audience that provide value to an agent, buyer, or seller involved in sales or purchase of real estate. Examples of such promotions include but are not limited to open houses open to buyers and their agents, open houses open only to agents, and featured listings where a property and one or more of its selected characteristics are emphasized through the invention.

According to one preferred embodiment of the invention, the targeted audience is determined by comparing the features of the promoted property with desired features previously selected by potential buyers and/or their agents. According to another preferred embodiment, the targeted audience is a group of agents determined in a similar manner. In the preferred embodiment, before a person pays for a promotion, he or she is provided with the results of the comparing process so that he or she has a reasonable estimate of the targeted audience that will receive the promotion.

In one embodiment, a computer-implemented method of creating a promotion for a real estate service by at least one real estate agent associated with the real estate service is provided. The method may comprise offering to one or more participants one or more promotions that can be selected by a participant and allowing a participant to select and create a promotion for a particular property to be promoted. The method may further comprise comparing preselected features of the particular property with information already in the real estate system to determine the recipients of the promotion, and sending promotional materials to the recipients determined through the comparing step.

In another embodiment, a computer-implemented method of providing one or more promotions through a real estate service having access to a plurality of participants and to real estate data regarding properties, property features, participants, and participant criteria is provided. The method may comprise offering to one or more participants one or more property promotions that can be selected, and allowing a participant to select a promotion for a particular property to be promoted. The method may further comprise comparing preselected features of the particular property to be promoted with participant criteria to determine matching participants, sending promotional materials to the matching participants determined through the comparing step, tracking responses of matching participants to the selected promotion, and providing the participant selecting the promotion with information associated with the responses of matching participants to the promotion.

In another embodiment, a system for providing one or more promotions through a real estate service having access to a plurality of participants and to real estate data regarding properties, property features, participants, and participant criteria is provided. The system may comprise a processor and a memory. The processor and the memory may be configured to perform a method comprising offering to one or more participants one or more property promotions that can be selected, allowing a participant to select a promotion for a particular property to be promoted, and comparing preselected features of the particular property to be promoted with participant criteria to determine matching participants. The method may further comprise sending promotional materials to the matching participants determined through the comparing step, tracking responses of matching participants to the selected promotion, and providing the participant selecting the promotion with information associated with the responses of matching participants to the promotion.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments of the invention and together with the description, serve to explain the principles of the invention. In the drawings:

FIG. 1A depicts an exemplary system environment, consistent with an embodiment of the present invention;

FIG. 1B is a block diagram of an exemplary Real Estate Manager module, consistent with an embodiment of the present invention;

FIG. 2A is a flowchart of an exemplary method for creating promotions, consistent with an embodiment of the present invention;

FIG. 2B is a screenshot of choosing a promotion, consistent with an embodiment of the present invention;

FIGS. 3A-3L are screenshots of a Buyer Open House promotion, consistent with an embodiment of the present invention;

FIGS. 4A-4K are screenshots of a Buyer Featured Listing promotion, consistent with an embodiment of the present invention;

FIGS. 5A-5H are screenshots of an Agent Featured Listing promotion, consistent with an embodiment of the present invention;

FIGS. 6A-B are screenshots of a promotion reminder splash page, consistent with an embodiment of the present invention;

FIGS. 7 is an exemplary Featured Listing brochure, consistent with an embodiment of the present invention;

FIG. 8 is an exemplary Open House brochure, consistent with an embodiment of the present invention;

FIGS. 9A-C are exemplary agent morning reports, consistent with an embodiment of the present invention;

FIG. 10 is an exemplary buyer morning report, consistent with an embodiment of the present invention;

FIG. 11A and 11B is an exemplary screenshots of an agent account, consistent with an embodiment of the present invention; and

FIG. 12 is an exemplary agent listing activity report, consistent with an embodiment of the present invention.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. Accordingly, the following detailed description does not limit the invention. Instead, the proper scope of the invention is defined by the appended claims.

As summarized above and explained in more detail below, the methods and systems of the present invention allow agents and/or sellers to better promote properties through a computerized system having access to a plurality of participants (preferably including buyers, sellers, and agents) and data and information regarding real estate properties, including properties offered for sale. The methods and systems of the present invention allow the owner of the system to offer to the participants promotions that can be reviewed, selected, defined, and, applied by the agent or any other person promoting a property, normally in return for a fee. Once a promotion is selected and paid for, the data within the system is reviewed and analyzed so that the promotions are sent to agents and/or buyers having matching criteria. In the preferred embodiments, an initial notice is provided and sent to the owners of the promoted properties and periodic notices, reminders, flyers and/or visual presentations regard the promotions are provided and sent to matching buyers and buyers' agents throughout the promotion. During the promotion, the responses of the buyers and buyer agents to the promotion are tracked and used to allow the promoting agents and/or sellers to become aware of the degree of interest and to generate reports and data for the promoting agents and/or sellers. The present invention preferably also allows interested participants to communicate regarding the promotion and promoted properties. According to preferred aspects of the invention, the systems and methods are preferably incorporated into a computerized real estate system having access to multiple listing services and a large number of buyers, agents, and sellers.

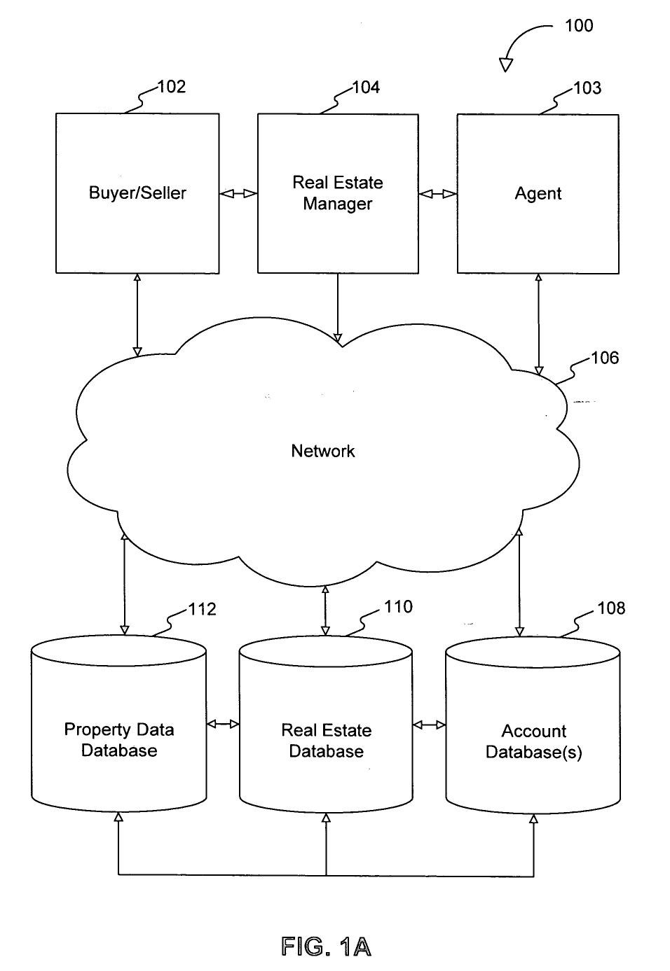

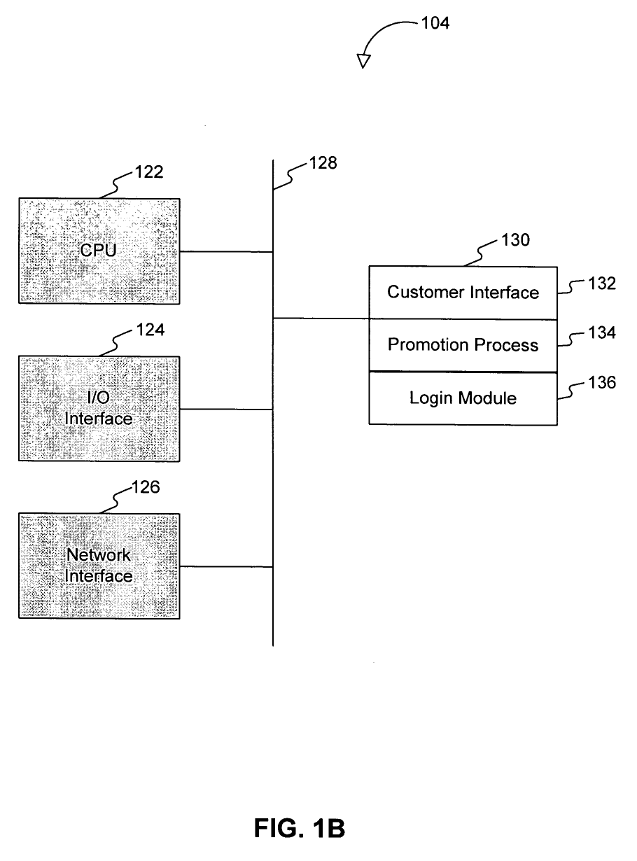

FIG. 1A depicts an exemplary system environment, into which the present invention can be incorporated. System 100 may contain one or more clients (buyers or sellers or both) (102) REVISE FIG TO INCLUDE REFERENCE TO BOTH BUYERS AND SELLERS, one or more agents 103, and a Real Estate (RE) Manager 104. The RE Manager 104 may be a computer or network of computers for supporting customer communications and data. RE Manager 104 may receive information on buyers and agents through network 106. Network 106 can be any data communications network including a combination of networks, such as the Internet, corporate intranets, a local area network, and other networks compatible with a networking protocol such as TCP/IP.

As shown in FIG. 1A, system 100 may also include several databases 108-112. Each database or set of databases in system 100 may include information that can be accessed through a database protocol such as, in one embodiment, Structured Query Language (SQL).

Real estate database 110 may contain information on listed and previously listed properties. In the embodiment shown, the database 110 comprises a Multiple Listing Service (MLS) database, which may be one of approximately 800+ presently existing database of real estate information. RE Manager 104 may also periodically access the real estate database 110, retrieve any updated information, and write the data from the real estate database 110 to the property data database 112. Thus, the property data database 112 comprises the data from the real estate database. Accounts database 108 may be a database or a set of databases that store information related to the various buyer and seller and agent accounts that are placed in the system and RE manager 104 may use. Accounts database 108 may include a seller database (not pictured) and a buyer database (not pictured).

FIG. 1 B is a block diagram of an exemplary RE Manager 104, consistent with an embodiment of the present invention. RE Manager 104 may include at least one central processing unit (CPU) 122, an I/O interface 124, a network interface 126, and memory 130. CPU 122 may execute instructions associated with the processes contained in memory 130 and transmit results to other subsystems of RE Manager 104 over a high speed interconnect or data bus 128. I/O interface 124 is an interface that may be used to couple RE manager 104 to devices such as a keyboard, a mouse, a display device, and any other I/O device useful in operating and managing RE manager 104, as is understood by one of skill in the art. The network interface 126 may be used to communicate with network 106 (FIG. 1A).

RE Manager 104 may be a server which comprises a web site and various database, communications, and other applications that assist in carrying out processes according to the present invention as described herein. The web site comprises web pages, both static web pages and dynamic web pages. Static web pages are web pages that comprise a file consistently available at the web site on the RE Manager/server 104. Dynamic web pages are web pages built by one or more of the applications and provided as part of the web site. Generally, the dynamic pages are built by accessing one or more databases. The RE Manager 104 is in communication with various databases 108-112.

According to the invention, an agent can provide all of his or her active buyers or sellers, or only selected buyers or sellers, with access to the system. The system and methods of the invention, on the other hand, can be applied in a computerized system where only agents have access to the system. The preferred embodiment is one in which at least selected buyers and/or sellers have access to the system, so that they can receive information regarding promotions provided according to the invention. In such a preferred system, the agent grants access to an agent's client by placing profile information regarding the client into the system, to set up an account for the client. The profile information included for a particular client can include the client's name and address, phone number, and email address. The information preferably further includes a seller's property and its features, or the type of property a buyer is looking for, the geographical areas of interest, the price range, and other feature criteria, including “like to have,” and “must have” features. In preferred embodiment, the methods of the present invention in turn notify the buyers and sellers that their accounts have been created and give them their respective logins and passwords. The system in operation creates data for each individual buyer and seller, and their agents. The agent and his client (buyer or seller) can access the information on these databases, at their respective individual convenience. Moreover, in the preferred embodiment, both the agent and client can review the databases and information at the same time and activate various system features, while they both are viewing the resultant webpages.

When an agent logs into the system, the system in a preferred embodiment queries the account database 108 to determine the agent's last login, identify new messages to the agent, check for appointments, and check for any items requiring action. The system also provides the agent with information regarding pending and previous promotions, as well as potential future promotions. The agent can activate any of these features to view specific reports. For example, if the agent wants to review buyer information, he selects buyer services from the menu bar. In a preferred embodiment, the system then provides the agent with the option of viewing a variety of reports, such as a buyer's report, or a viewed list, or a tagged List, or a buyer profile. As explained in more detail below, the agent can also review information and web pages relating to promotions that are offered and applied pursuant to the present invention.

An example of a computerized real estate system in which the present invention can be incorporated and applied is disclosed and illustrated in U.S. application Ser.No. 09/724,268,filed on Nov. 28, 2000and further amended on Feb. 26, 2006,the entire contents of which are herein incorporated by references. As explained in more detail in that application, RE manager 104 includes an online property information viewing system (not pictured). This system allows participants to view properties and features and characteristics of properties in the system. In one embodiment, the property information viewing system comprises two sub-systems for obtaining property information. The first, or primary, sub-system comprises a system whereby the buyer is provided access to search results showing property information that is the result of a comprehensive set of search criteria entered by the agent 103 for the buyer 102. The search criteria entered by the agent for the buyer 102 is saved and the results updated when the buyer 102 logs into the viewing system and activates a request for the first system (e.g., by a clicking on a hyperlink). The second sub-system is a the property information viewing system that allows buyers to select property features, conduct a search, and view detailed property information in relation to the property features selected by the buyer. The sub-system accesses a property information database 112 to provide such information to the buyer. The entire system is accessible by the buyer 102 and/or his or her agent via the Internet 106.

In the preferred embodiment, the buyer's activity using the system is monitored and recorded. For example, the buyer's view of detailed property information for a particular property is recorded in the account database 108. Similarly, if the buyer makes his or her own search or responds in some manner to promotions or promoted properties during the promotion, that is recorded and therefore available data in the system. These recorded responses can then be analyzed and used to provide valuable information to participants, be they agents, buyers, or sellers.

In an embodiment of the present invention, a real estate agent can use a personal computer (PC) to log into his or her account using a user name and password assigned to the agent. Sellers and buyers can also use their own computers to log into their accounts using user names and passwords assigned to them. Thus, under the present invention buyers, sellers, and agents can periodically review data and information available under the system, including promotions, and make decisions and communications in response to the data and information made available through the invention.

Under the invention, the agent can specify a profile for clients, such as sellers, potential sellers, buyers or potential buyers. By means of example only, the profile for a buyer can include buyer information such as first and last name of the potential buyer and property types and features of interest (e.g., single family or condo), price range, geographic area(s) of interest, and property features of interest (e.g., minimum number of bedrooms, minimum number of bathrooms, and minimum square footage). The buyer profile is stored in the accounts database 108 in association with the buyer name and the real estate agent name. Similar seller profiles can be created and stored. The agent may add further names and profiles at any time.

Under a preferred embodiment, an agent when entering buyer information selects what features of the system the buyer will be able to use. The agent, for example might allow the buyer to use both a buyer report and the property lookup features. The agent selects the type of properties the buyer is interested in, and the location of the buyer's interest. For instance the agent may enter a MLS area, from a table the system provides to the agent. The agent can add additional areas, or can select certain areas by, for example, sub-divisions or schools. The agent also selects the type of property of interest (.e.g. single home, townhouse, condominium, or all) and the size of the home of interest. The present invention preferably includes an advanced areas Wizard that allows the agent to follow a step by step process of selecting sub-divisions, complexes, or school districts, by means of example only. The agent can also select only certain counties, geographical areas, or school districts as of interest to the buyer. The agent also enters the price or price ranges of interest to the buyers. Preferably, the agent will also select from a list of features those features that the buyer must have and those that the buyer would like to have. The invention preferably includes an extensive list of features, such as square footage, number of bedrooms, number of bathrooms, location, and so forth) that can be selected as must have or like to have.

The RE Manager 104 may provide a web page to the agent 103. The agent can then view the options and services available and go to desired options or services by activating a designated hyperlink. RE Manager 104 achieve this by accessing the databases 108-112 having information associated with the agent and the selected option or service.

In one embodiment, the systems and methods of the invention are incorporated into a server system in which agents, buyers, and sellers can access the system through the Internet. In a preferred embodiment, when the agent logs into the system, he is provided with a Frontpage From that page he can select a variety of options that might include, for example, Buyer Services, Seller Services, Message Center, To Do List, and Help. The Frontpage preferably includes a hyperlink that allows the agent to learn what promotions are available under the present invention, the features and costs of the promotions, and the procedures for selecting, defining, and paying for and reviewing the promotions. The agent's web page preferably allows the agent to send or review messages from any of these options. The agent has an Inbox that identifies messages received, as well as approaching due dates. Sellers and buyers of the agent are provided similar accounts and options. The agent can decide what options his clients (sellers or buyers) or other persons that he grants access (customers) can use, when they log into the system.

In an embodiment of the methods and systems of the present invention, the property database of the system is periodically updated, preferably several times a day. Preferably, the agent and his clients (buyers and sellers) can initiate searches through the databases, and the databases at times automatically are searched by the system, as the system updates information or responds to logins or requests from a user. Search requests, results of searches, and other selections and uses of the system by users are tracked and recorded in databases, for future use.

In one embodiment, memory 130 of RE Manager 104 may include: customer interface process 132 that may have program instructions that, when executed, receive the real estate information from buyer 102 and/or agent 103 (FIG. 1A); promotion process 134 that may have program instructions that, when executed, offers and applies one or more real estate promotions to buyer 102 and/or agent 103; and login module 136 that may have program instructions that, when executed, verifies login of the website for a buyer and/or agent.

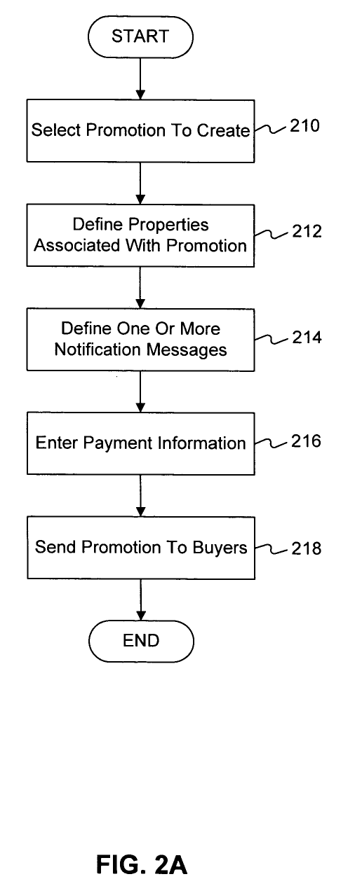

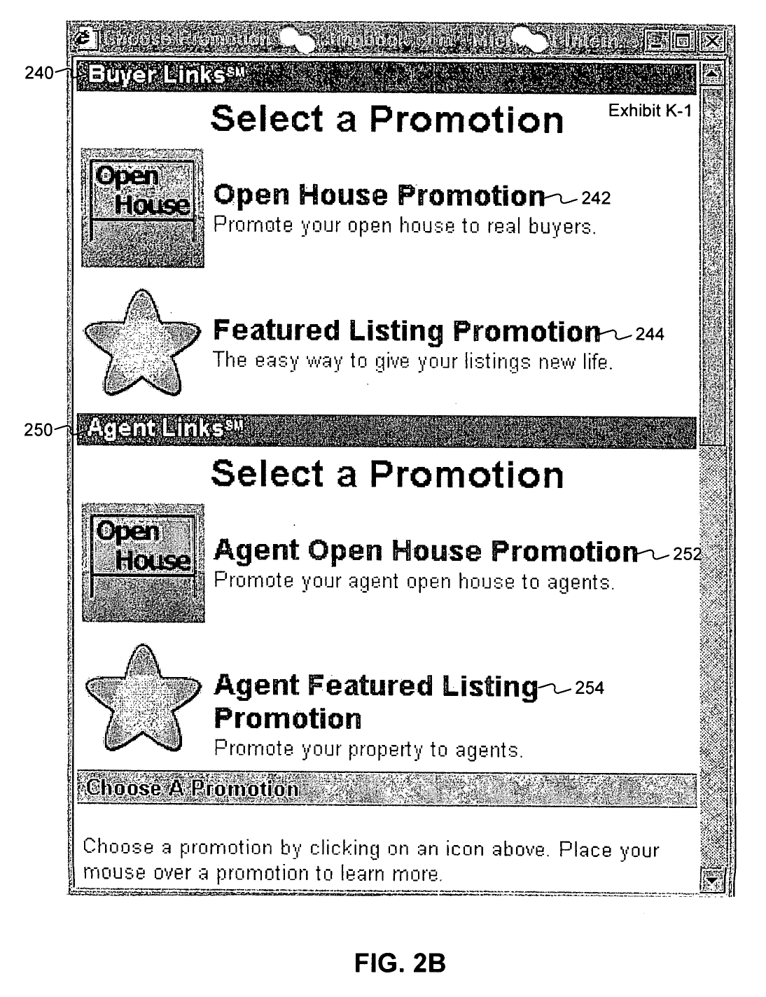

FIG. 2A is a flowchart showing an example of some of the steps of a method for offering promotions to an agent, consistent with the systems and methods of the present invention. Promotions provided under the present invention include any promotions that assist in the sale of a property being promoted and that are of value to the seller of the property, or the agent, or both. The promotions of the present invention are preferably offered and applied through a computerized system that can be periodically accessed by users, at their convenience. Examples of promotions according to the present invention include but are not limited to a Buyer Featured Listing (BFL) promotion, a Buyer Open House (BOH) promotion, or an Agent Open House (AOH) promotion. Preferred embodiments of each of these promotions are discussed in greater detail below. Moreover, each of these promotions may include a variety of different features that can increase the promotion's effectiveness and value. While a variety of different promotions and features are disclosed in this specification, the full scope of the present invention is not limited to any particular promotion or any particular combination of features provided with a type of promotion.

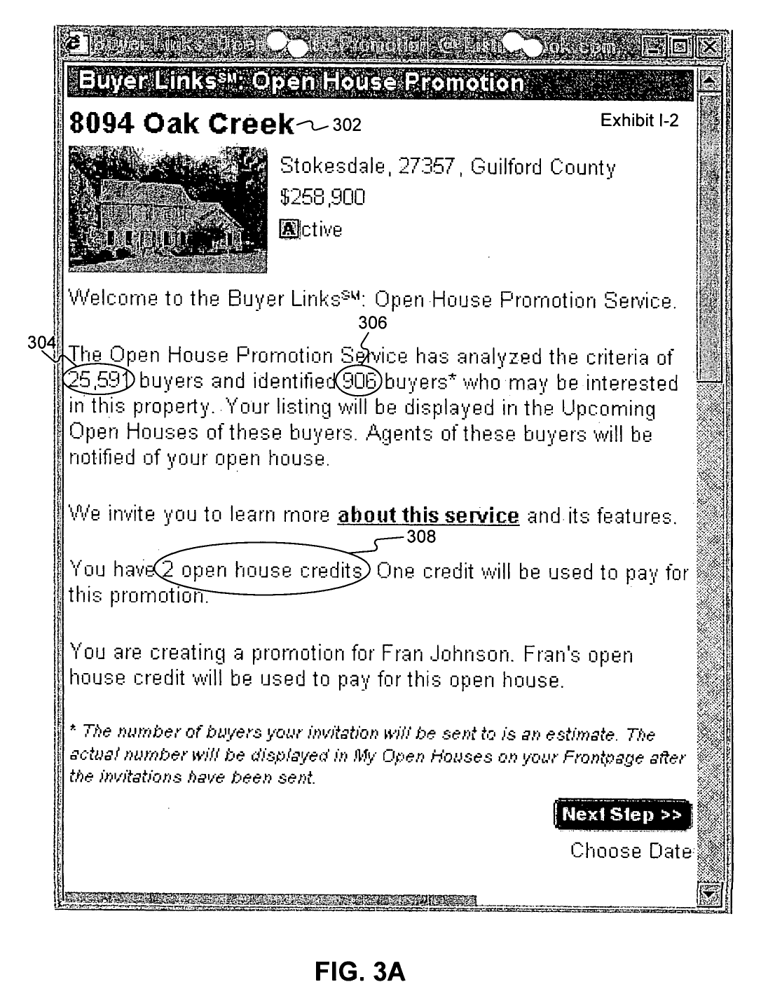

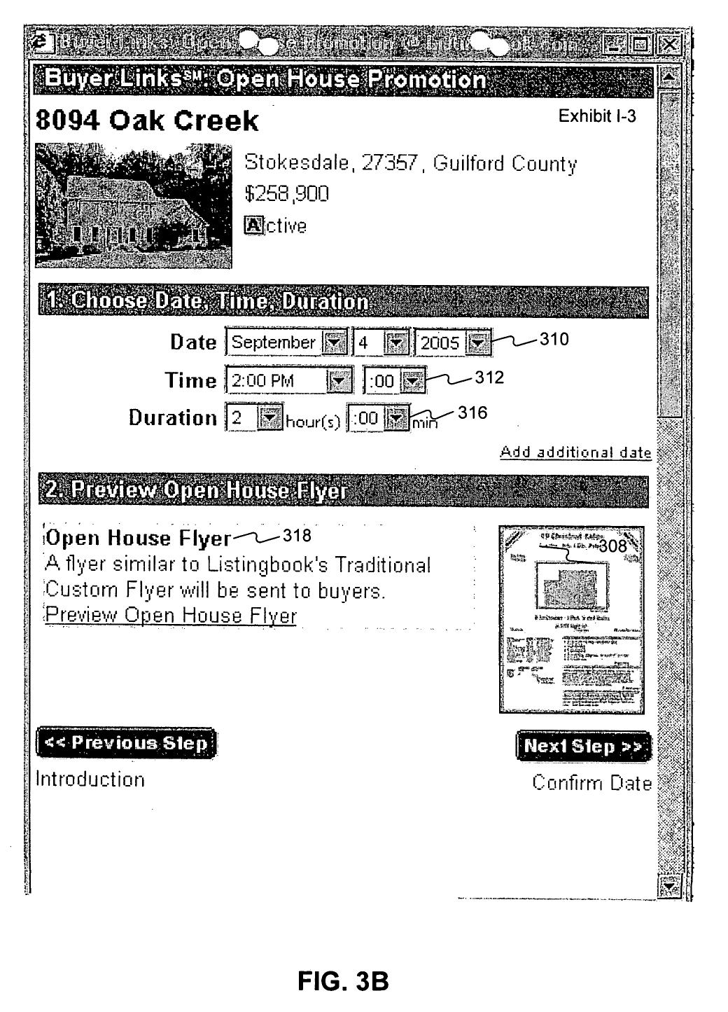

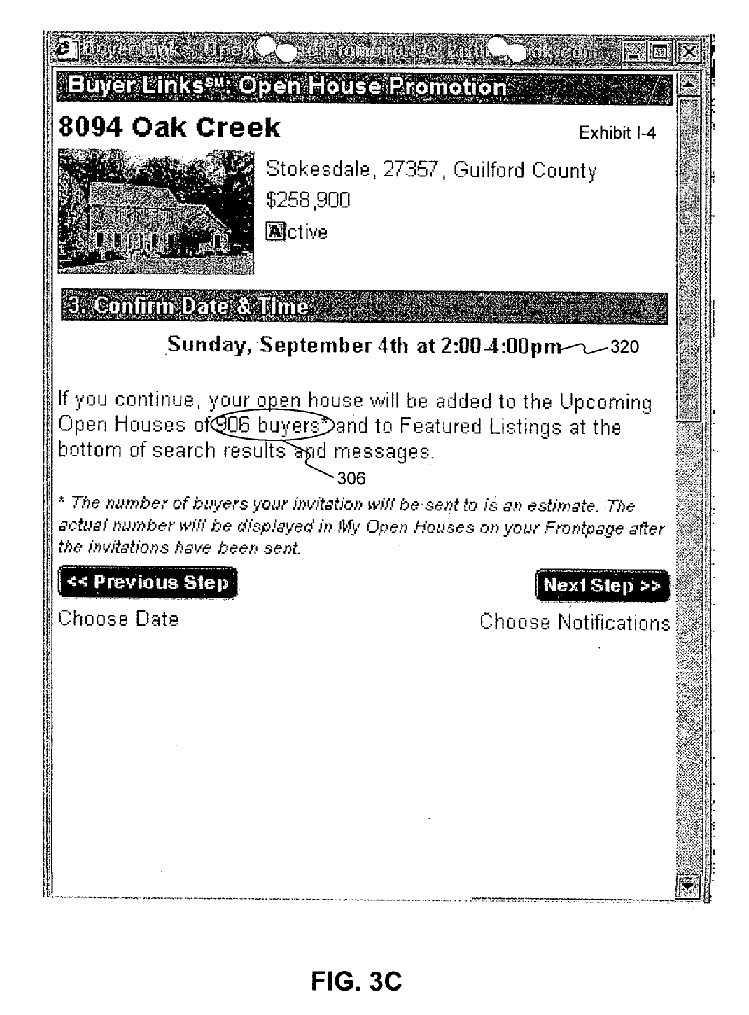

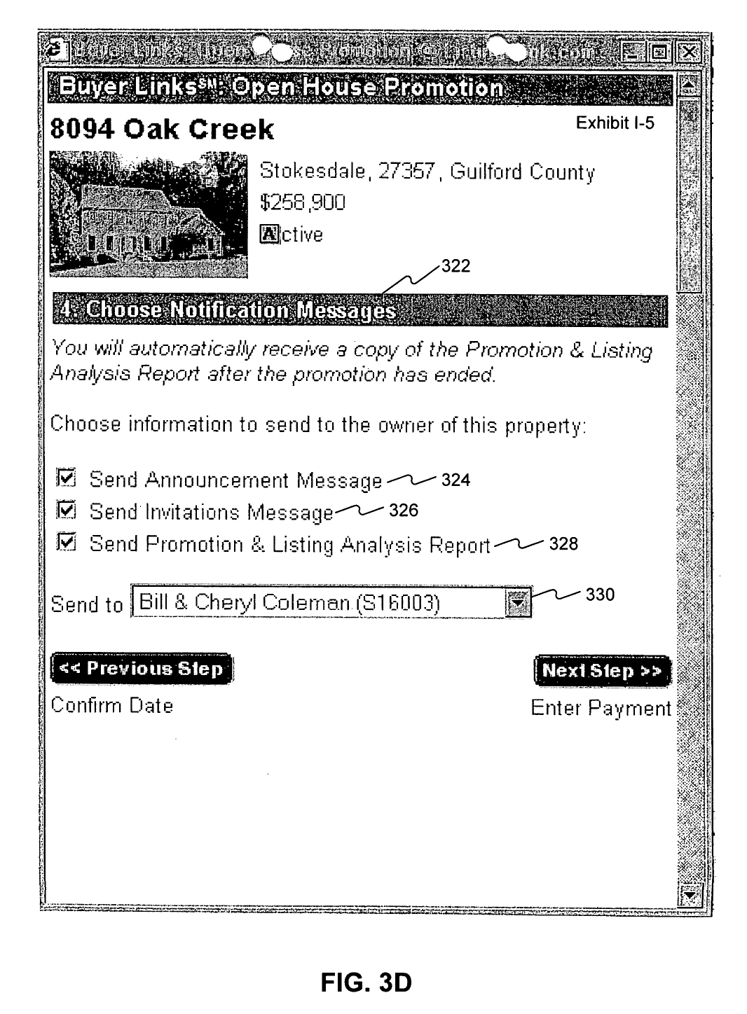

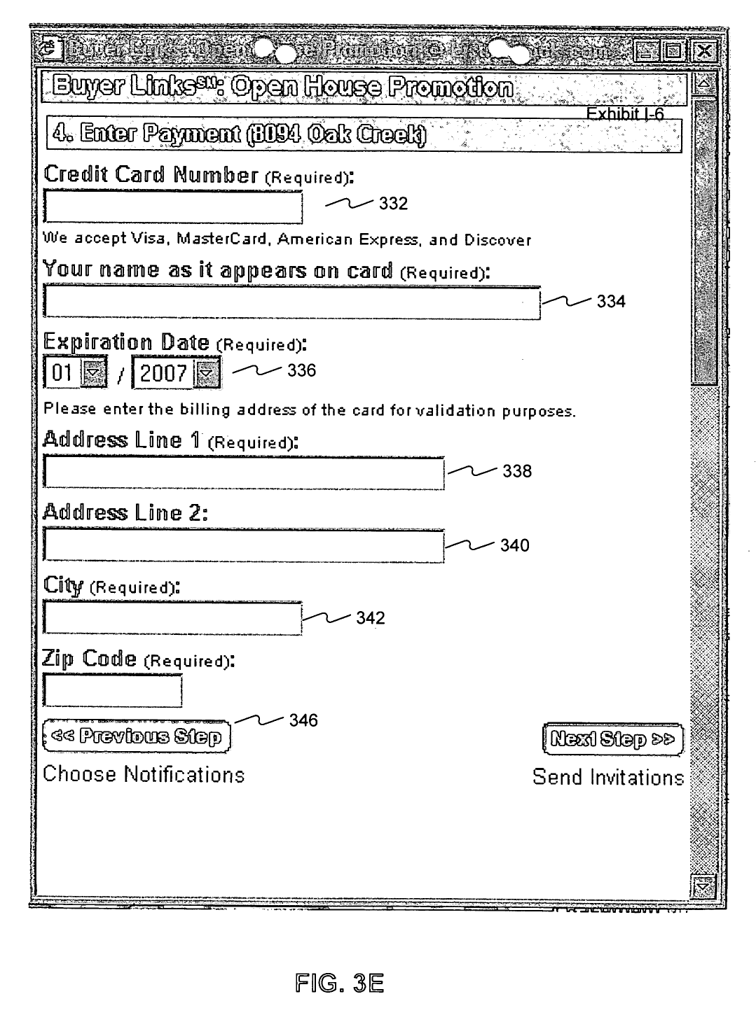

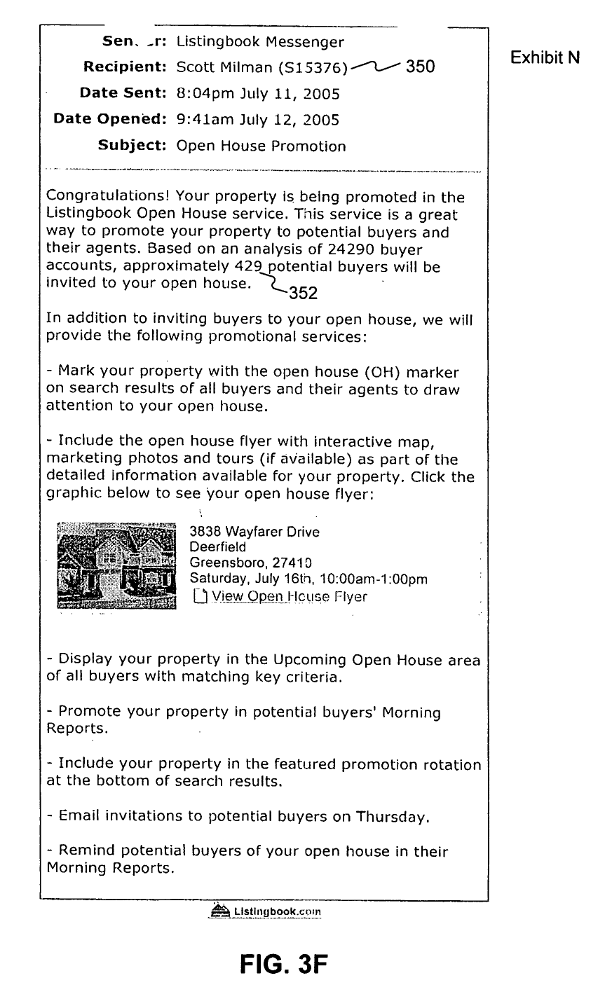

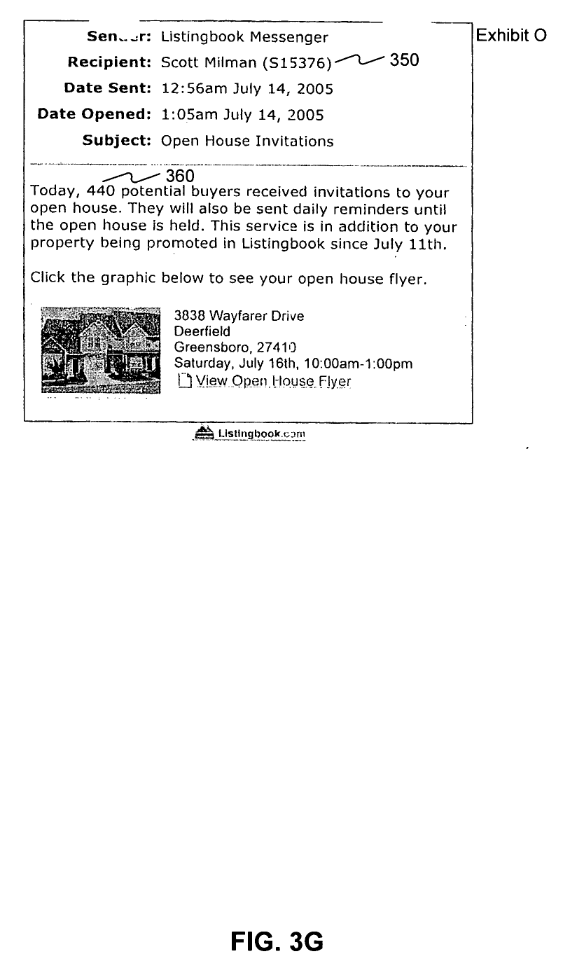

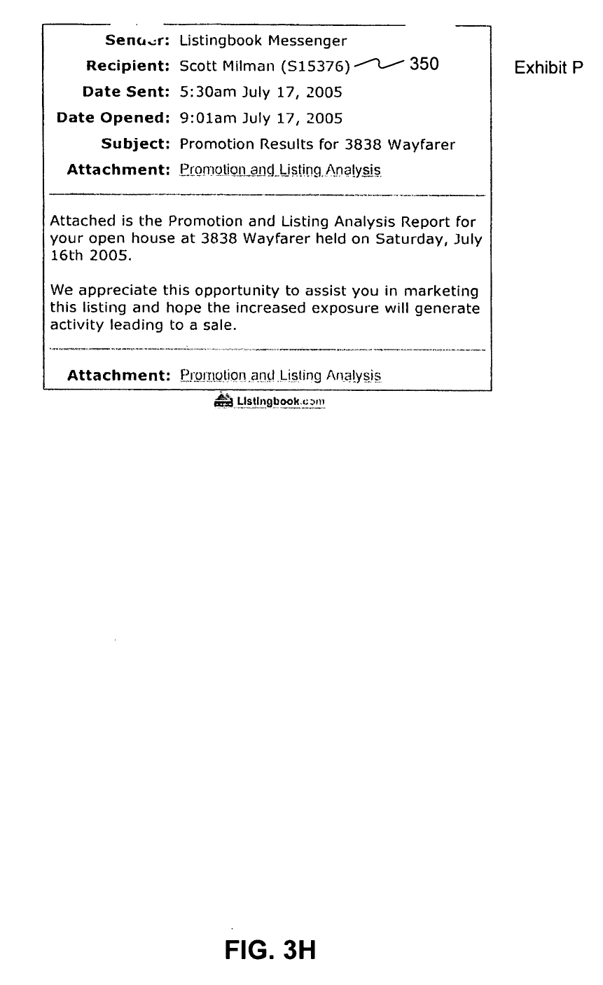

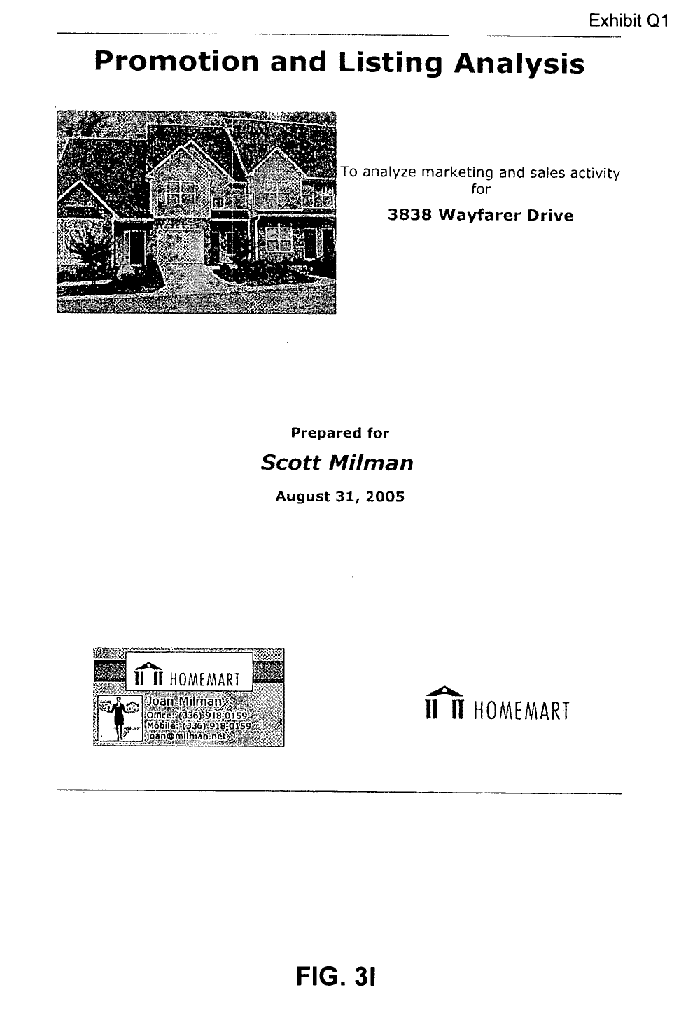

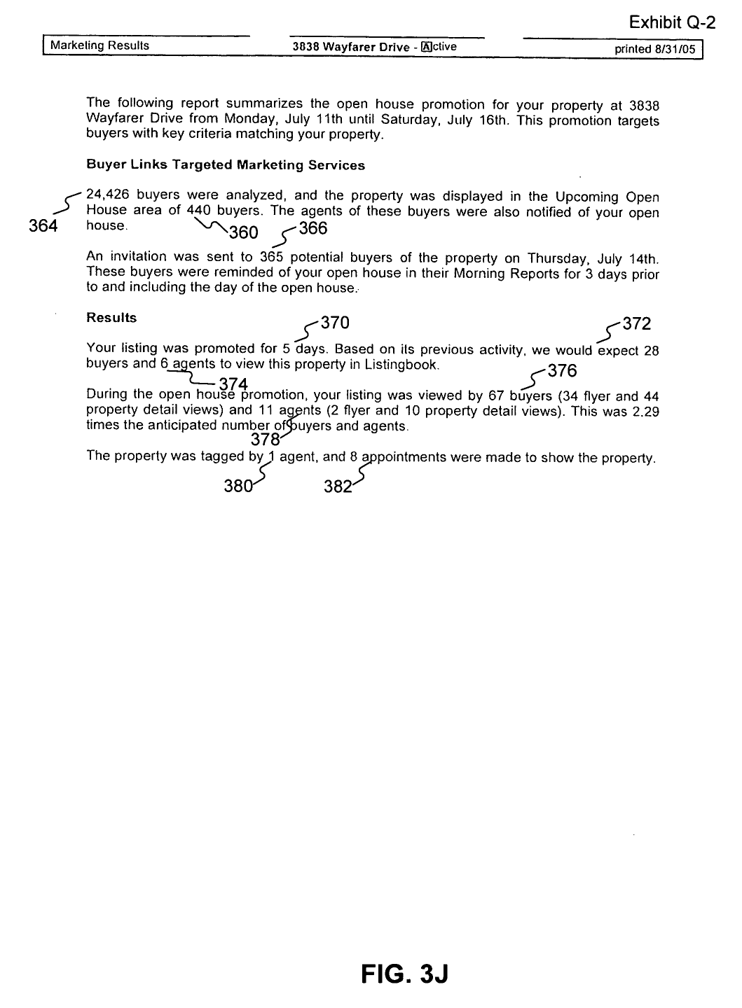

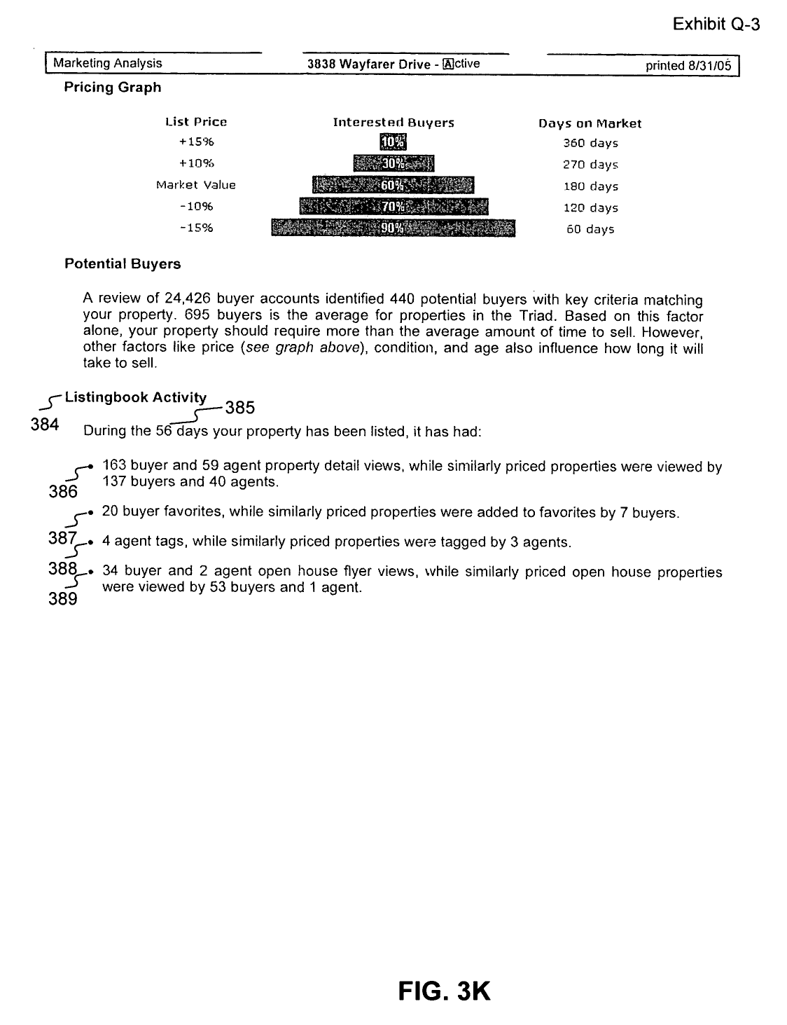

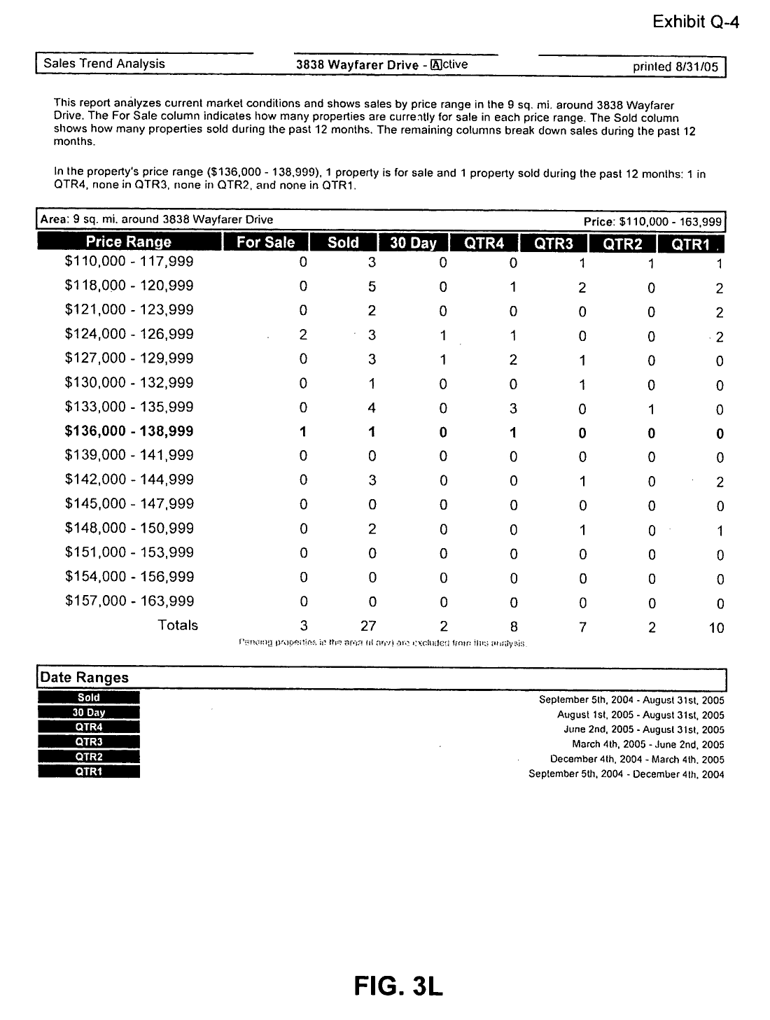

As shown generally in FIG. 2A, the agent may first select a promotion to create from the list (stage 210). Once the agent has selected the desired promotion, the agent 103 may identify the property to be promoted and define the various properties associated with the promotion (stage 212). Each of the promotions has various features the agent 103 has to consider and either select or otherwise define. The properties of exemplary promotions are disclosed in greater detail below with respect to FIGS. 3-5. Once the properties of the promotion are defined by the agent 103, the agent may determine whether to send one or more notification messages to the seller of the promoted property or along with the promotion to the buyer(s) who will receive the promotion (stage 214). Preferably, the agent is provided with some idea of how many available buyers match the promoted property and therefore will receive the promotion, along with an indication of the cost of the promotion. The agent therefore can determine whether the potential number of matches, defining the targeted audience, at a given time justify the costs of the promotion at that time. Once the agent has completed the selection and definition of a desired promotion, the agent may then enter payment information associated with the promotion (stage 216). After the payment information has been entered, the promotion may be displayed to one or more buyers and/or agents, as determined by RE Manager 104.

Each promotion may be sent to one or more buyers based on different criteria (stage 218). By means of example, for a BOH or an AOH promotion, the promoted property features need to match certain key elements of the buyer's search criteria. The key elements can include a number of different criteria, such as, for example, the type of property, area, price range, levels, beds, and acreage. If the key elements of a buyer's search criteria for a desired property match the features of the property of the promotion, then that buyer and his or her agent will receive the promotion. By means of example only, for a BFL promotion a buyer will receive this promotion if the features of the property in the FL matches the key elements of a buyer's search criteria, or was previously selected as a favorite property by the buyer. This process is described in greater detail with regard to FIGS. 2B-11.

FIG. 2B is an exemplary screenshot of examples of various promotions an agent 103 can select consistent with an embodiment of the present invention. When an agent 103 logs into the website generated by RE Manager 104, the agent is greeted by a Frontpage. In the Frontpage, the agent 103 has the ability to create one or more promotions to buyers (and their agents) that have search criteria that matches a property listed by the agent 103. An agent 103 can select either a Buyer Links promotion 240 or an Agent Links promotion 250. A Buyer Links promotion 240 is a promotion that is sent to buyers with matching search criteria in their profile and their agents. An Agent Links promotion 250 is a promotion that is sent to other agents who have buyers with matching search criteria in their profile.

An agent 103 may choose to promote an Open House (OH) 242 and/or a Featured Listing (FL) 244. Through a Buyer Open House (BOH) promotion 242, an agent can promote an OH to buyers with key search criteria in their profile that match the promoted property. A Buyer Featured Listing (BFL) promotion 244 can be used to promote a property that the agent or the seller feels deserves additional promotion, perhaps because it is no longer receiving buyer/agent attention or because of a change in circumstance, such as price or feature. In both of these promotions, an agent 103 is able to send information on the property to buyers and agents of these buyers who have search criteria in their profiles that match the features associated with the featured listing.

An agent 103 may also choose to promote an Agent Open House (AOH) 252, an open house that is only promoted to and attended by agents. Through an ALOH 252, an agent can promote an OH to other agents who represent or might represent buyers who might purchase the property. In a preferred embodiment, the notices of a AOH are sent to agents having one of more buyers with key elements of the search criteria matching the elements of the BOH property. Through this service, the agent having the AOH can advise the potential agents of special terms or conditions that might be available to the agent who sells the home. AOH promotions allow agents to meet and discuss how best to sell the property and to consider various promotional arrangements between the listing and purchasing agent that might otherwise not be considered or available. In use, this service can replace conventional approaches including flyers sent by fax, phone calls, and emailed messages. Each of these promotions is discussed in greater detail below.

FIGS. 3A-3L are screenshots of a BOH promotion, consistent with an embodiment of the present invention. These screenshots illustrate and disclose features of one embodiment of a BOH promotion according to the present invention. An agent 103 may first select a particular property associated with the agent 103 for the OH promotion. In the example in FIG. 3A, the agent 103 has selected the property at “8094Oak Creek” 302 for the OH promotion. After the agent 103 selects the particular property for the OH, RE Manger 104 may analyze all the buyers' profiles in accounts database 108 to determine whether any of the buyers have key elements of their search criteria that match the OH property features. In order for the OH to be sent to any buyer 102, the OH property needs to match the key elements of the buyer's search criteria. Different key elements, such as type of property, area, price range, levels, beds, and acreage, can be preselected and used in a comparing process to determine matching buyers and their agents for a particular promoted property.

RE manager 104 may then list the number of buyers analyzed and the number of buyers that have matching interests in the property. Thus, the methods and system of the present invention provide the potential requestor with an estimate of the targeted audience, before the promotion is further defined and paid for. In this example, the number of buyers 102 that may be interested in the property is the number of buyers that have key elements of the search criteria that match the OH property features. For example, as shown in FIG. 3A, “25,591” 304 buyers' profiles were analyzed (generally the total number of buyers in the system looking to purchase a property) and “906” 306 buyers were identified that may be interested in the property (the number of matching buyers that would be the target audience). Therefore, “906” buyers were identified that had key elements of their search criteria match the property details associated with the OH. Thus, at this point of the process, the agent learns a good approximation of the number of buyers that would receive a promotion, thereby allowing the agent to consider the value of the promotion relative to its costs, at that time.

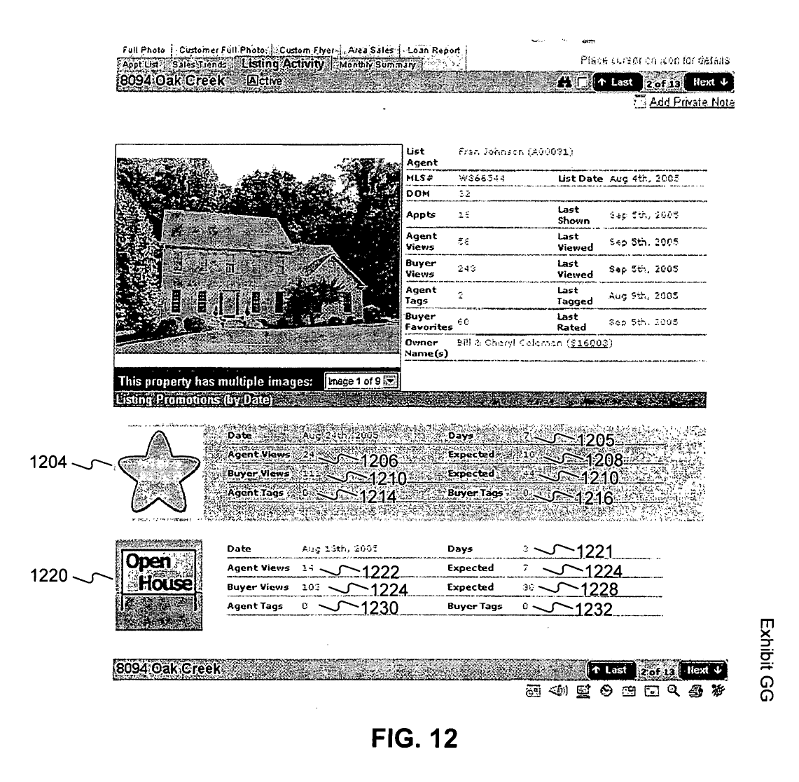

If the agent concludes that he or she wants to continue, the agent then completes the selection and creates the promotion. Once an OH promotion has been created by the agent 103, the agent 103 is notified that the listing will be displayed in the upcoming open houses for these buyers in the buyer's Frontpage (cf. FIG. 12A, 1202). RE Manager 104 in the preferred embodiment may also identify the agents associated with the particular buyers who were identified and will notify these agents of the OH. The agents 103 may be notified of the OH on the Open Houses page of their Buyer List.

When creating a OH, the Agent 103 may then select a date 310, time 312, and duration 316 for the OH as shown in FIG. 3B. In one embodiment, if more than one day is needed for the open house, an additional date can be added. Once the agent 103 completes setting up the details of the OH, the agent 103 may then preview an OH flyer 318, created by the system from data in the system, which provides the details of the OH. This flyer may be viewed by system users when viewing the OH property details page.

At any point in setting up the OH, an agent 103 may go back a previous step or forward to the next step in setting up the OH. After the agent has set up the OH details, a confirmation is shown to the agent 103 before the OH promotion is initiated. The total number of buyers that will receive the OH, in this case “906” 306 buyers, are shown to the agent 103.

Once the agent 103 has confirmed the date and time of the OH, the agent 103 may select one or more notifications 322 that are sent to buyers and/or other agents as shown in FIG. 3D. The notifications may also be sent to the owner of the property of the OH. The agent 103 may select to send an announcement message 89. The agent 103 may also select the name of the owner of the property from a pull down menu 330 who will receive these notification messages.

Once the agent 103 has completed the selections and definitions of the promotion, the agent 103 will pay for the promotion, either through credits the agent already has or by making payment at that time. In a preferred embodiment where the agent has not previously paid for this promotion service, the agent is prompted to enter payment information as shown in FIG. 3E. Payment information may include a credit card number 332, the name as it appears on the credit card 334, an expiration date for the credit card 336, the billing address associated with the credit card 338 and 340, city 342, and zip code 346. Once the agent 103 enters in this information, RE Manager 104 can charge the credit card for the cost of the promotion. Each offered promotion under the present invention may be priced differently. Once the credit card is approved, the promotion process is applied. Preferably, a notification message is sent to the owner (normally the seller) 330 of the selected property.

FIG. 3F shows an exemplary announcement message 324 sent to the seller informing the seller of the open house. In the example on page 3F, the recipient of the OH message is “Scott Milman” 350. The announcement message informs the seller of the property that the agent 103 has promoted their property as an OH. The seller is notified of the number of people that are invited to the open house 352. In this example, the seller “Scott Milman” will see that “429” potential buyers are invited to the Open House. The seller is notified that in addition to inviting the buyers to the OH, their property will be marked with an OH marker on all search results, an OH flyer will be available as part of the detailed information available for the property when other buyers and agents view the property, the property will be listed as an upcoming OH in the buyer's Frontpage if the OH matches their key search criteria, and the OH will be in the buyers' morning reports if the OH matches their key search criteria. The seller of the property may receive this notification as a message in his or her Inbox.

If the agent 103 chose to send the owner a notice that the OH invitations were sent 326, then once the OH invitations are sent to buyers that have key search criteria that match the OH property, the property owner is sent the notification as shown in FIG. 3G. The property owner is notified of the number of people 360 that received the OH invitation. In this example, the seller “Scott Milman” 350 is notified that “440” 360 potential buyers received an invitation to the OH created by the owner's agent.

According to the present invention, when a promotion is purchased and effected, the system can create and provide reports to the users. For example, if the agent 103 chooses to send a promotion and listing analysis report 328, then the seller is sent the message as shown in FIG. 3H explaining that the Promotion and Listing Analysis (PLA) report for the OH is attached to the message. FIG. 31-3L is an exemplary PLA report for the OH. The PLA preferably is automatically sent to the listing agent promoting the property.

The PLA report is a detailed report that summarizes the OH promotion created by RE manager 104. The report may inform the recipient (agent or seller) of the number of buyers that were analyzed 364 to determine if they should receive information on the OH. The report informs the recipient of the number of buyers 360 who received information on the OH in the upcoming OH area of the buyers' homepages. The report further informs the recipient of the number of potential buyers 366 who received the invitation for the OH. The report may also inform the recipient of the number of days the listing was promoted for 370. The report also may give the recipient an estimate of the number of buyers 372 and agents 374 who normally would have viewed the property in the service. The calculation of the average views and tags may be based on the number of days the property was listed prior to the promotion and known averages or statistical analysis of data and information in the system, performed by the system.

The report also informs the recipient of the activities that took place during the OH. For example, the report may inform the recipient that during the OH promotion, the listing for the promoted property was viewed by a certain number of buyers 376 as well as the number of agents who viewed the property 378. RE Manager 102 keeps track of each time a buyer views any property as well as each time an agent views a property, by recording responses and storing the responses for future analysis and use. This information may be stored in accounts database 108 under the respective agent account. Viewing by buyers and/or agents may be in one or more forms. For example, a buyer or agent may have viewed the property through an OH flyer or a property detail view. A property detail view is where the buyer 102 selects the particular property from a list of properties and chooses to view the details of the property. The report may further notify the seller of the number of agents 380 that tagged the property, or identified a property as a “favorite.” When viewing property summaries for a particular buyer name, the agent can “tag” certain properties of interest. For example, when viewing the new activity web page for a certain buyer, the agent can click a “Tag” check-box associated with a particular property. By tagging a particular property,the property is added to a list of tagged properties for that buyer. In similar fashion, a buyer can “Tag” properties of interests to him or her. Each time any property in the real estate database 110 is viewed by an agent or buyer, tagged, or designated as a favorite, the RE Manager 104 records these responses and keeps track of who made them and records them in the accounts database 110. The system preferably also allows persons, preferably a showing agent, at the open house to provide comments that can be stored in the database of the system and later used or analyzed. The system also allows users to make appointments and tracks and records such appointments. The system therefore can create notices and reports that may also inform the recipient of comments from a showing agent and/or the number of appointments 382 that were made to show the property to potential buyers.

The report may also summarize the activity for the system regarding the property 384. The summary may include the number of days the property was listed 385. The summary may include the number of buyers and agents that viewed property details of the property, as well as the number of views by buyers and agents of similarly priced properties 386. The summary may also include the number of buyers that listed this property as a “favorite” in their buyer account 387. The summary may also include the number of agents that tagged the property and also list the number of similarly priced properties that were tagged by the agents 388. The summary may also list the number of buyer and agent OH flyer views, and also list the number of OH property views of similarly priced properties 389. The flyer may be viewed anytime a person is viewing the property details of the OH property.

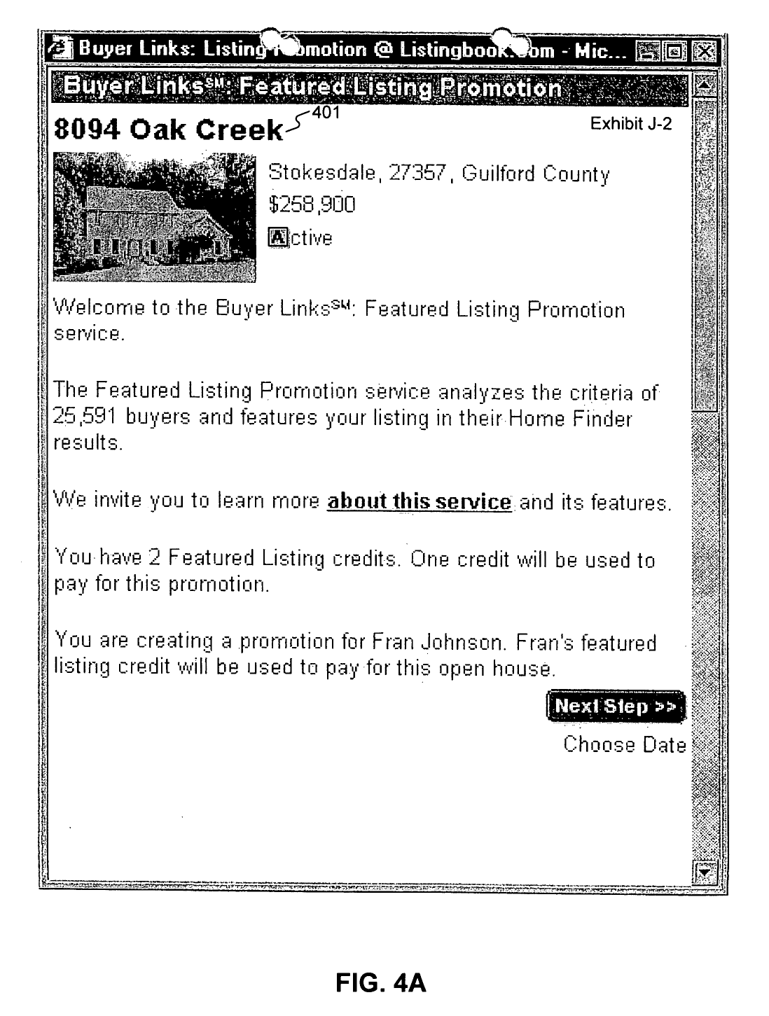

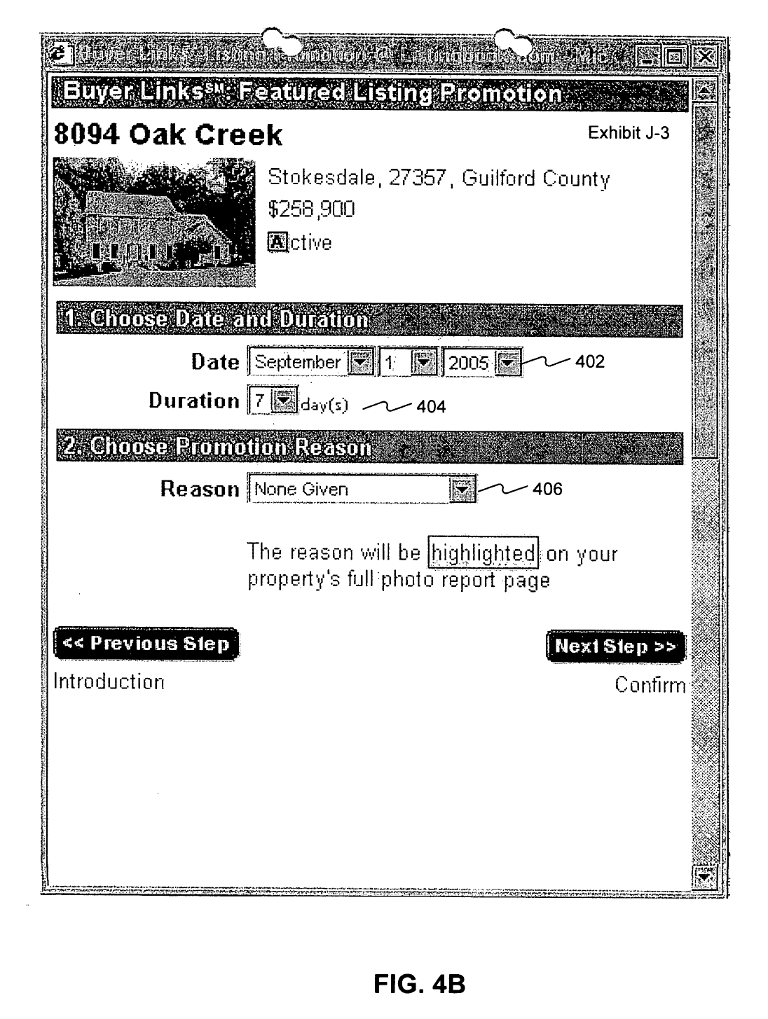

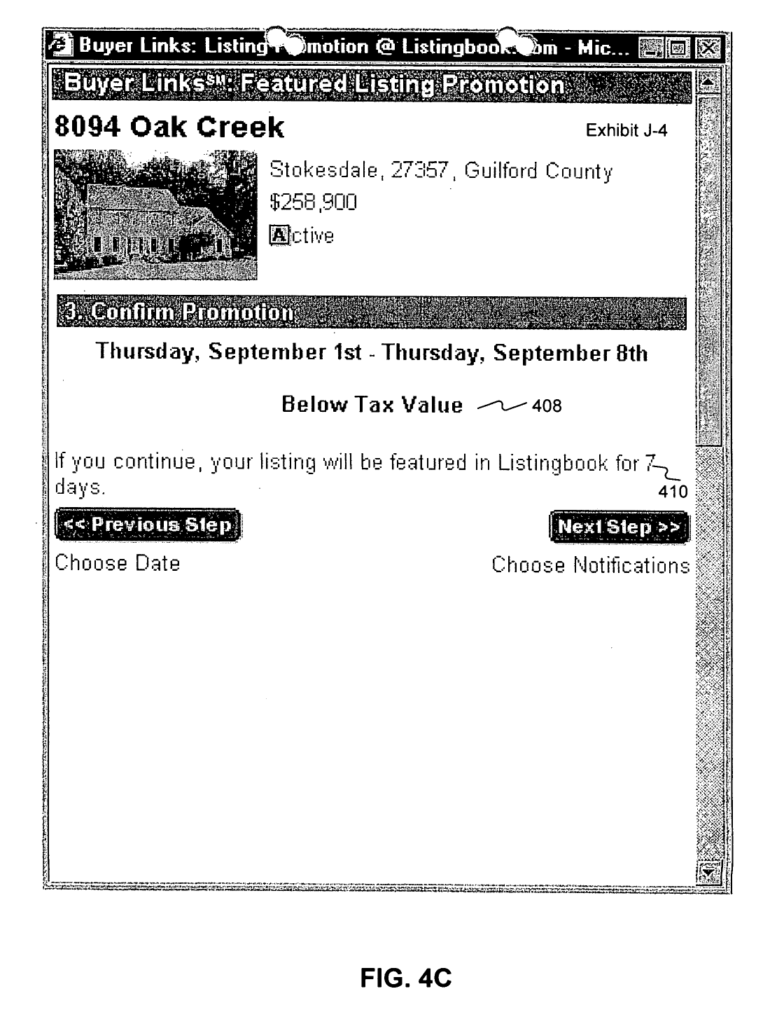

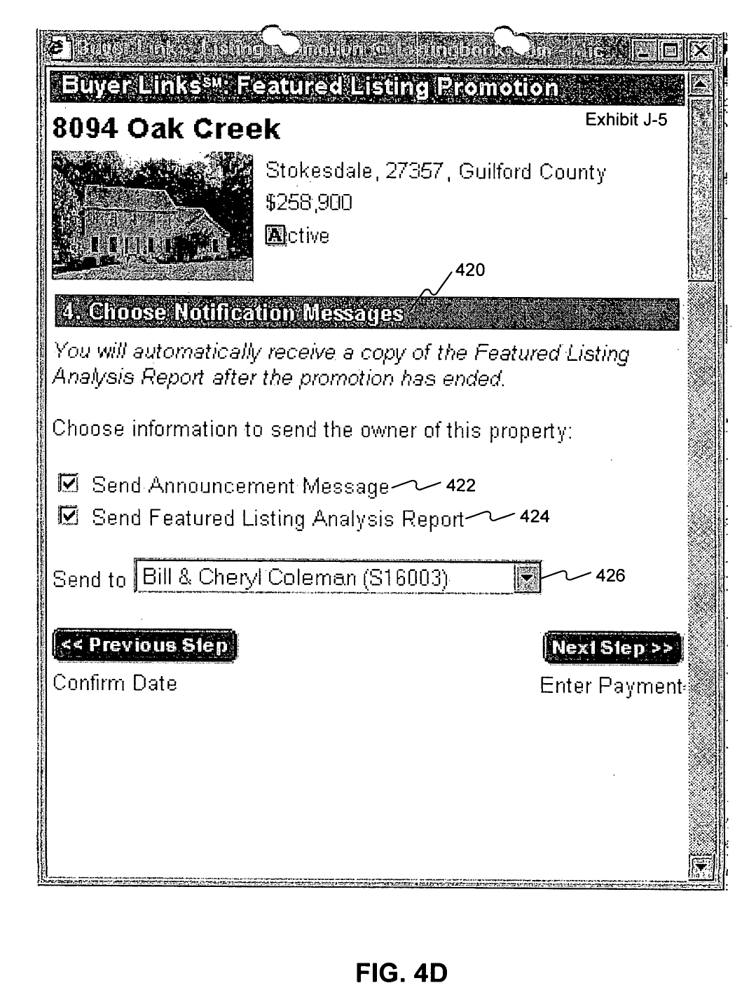

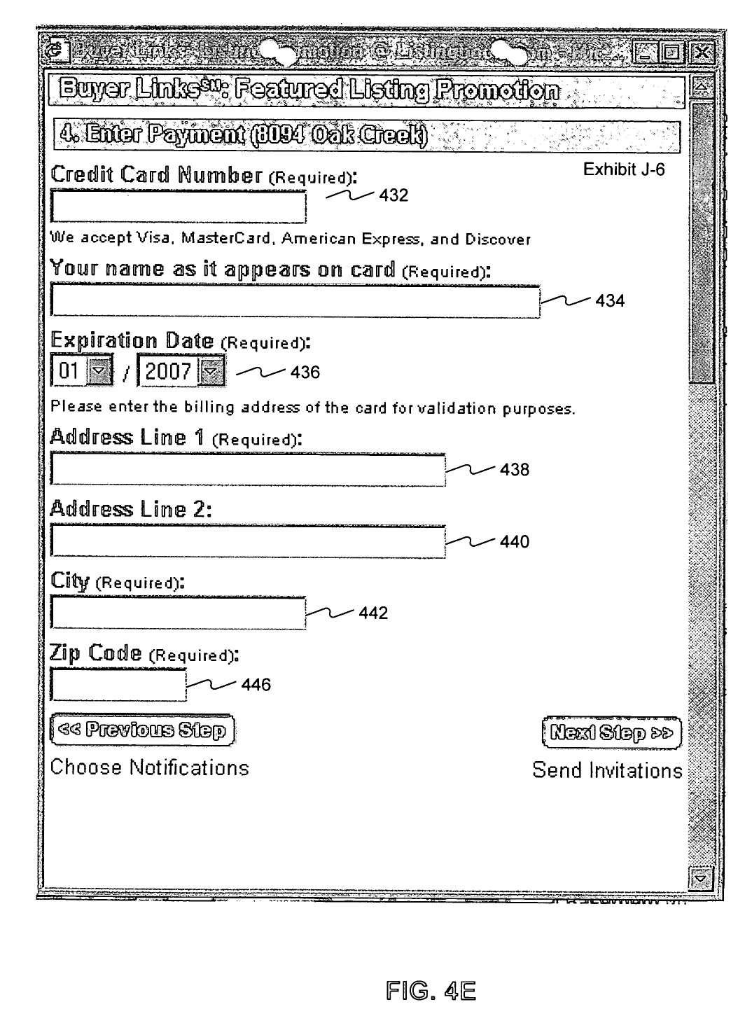

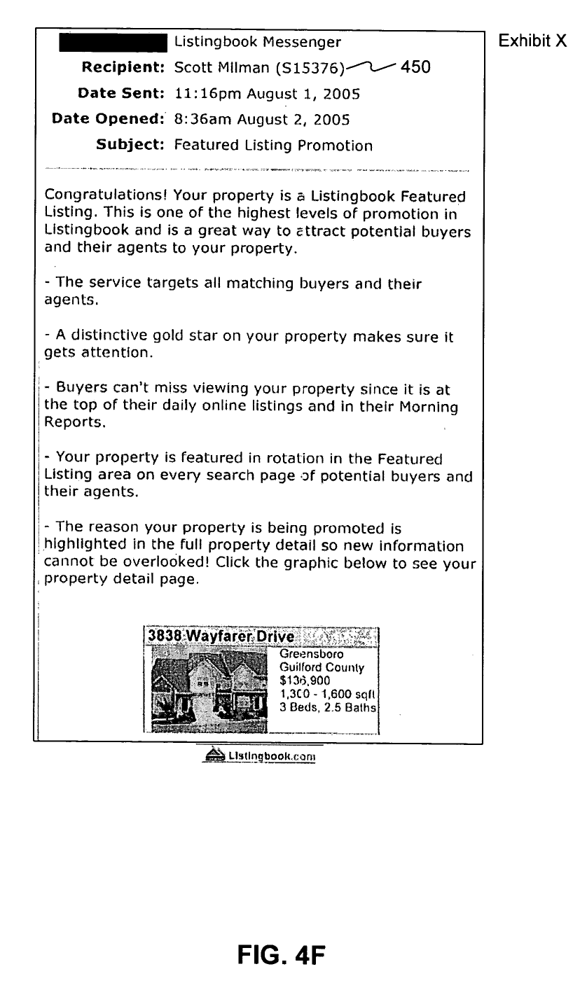

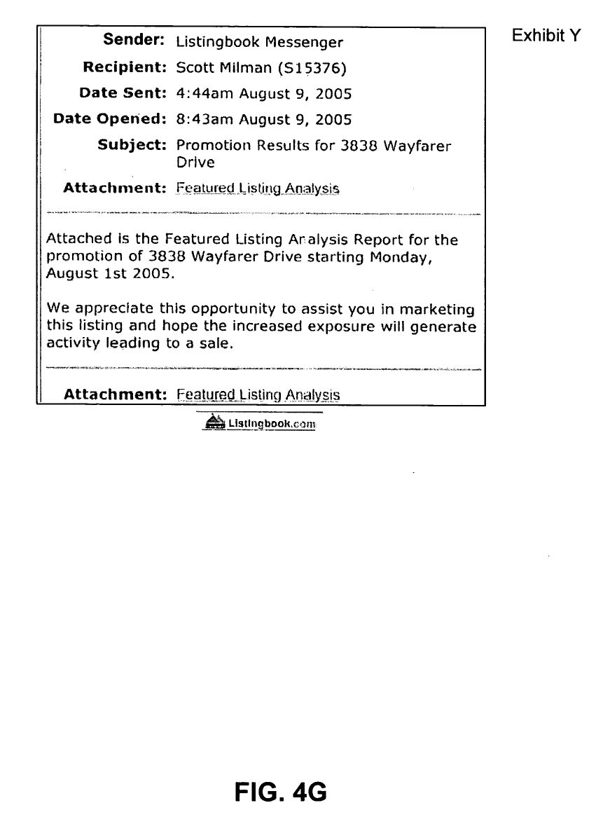

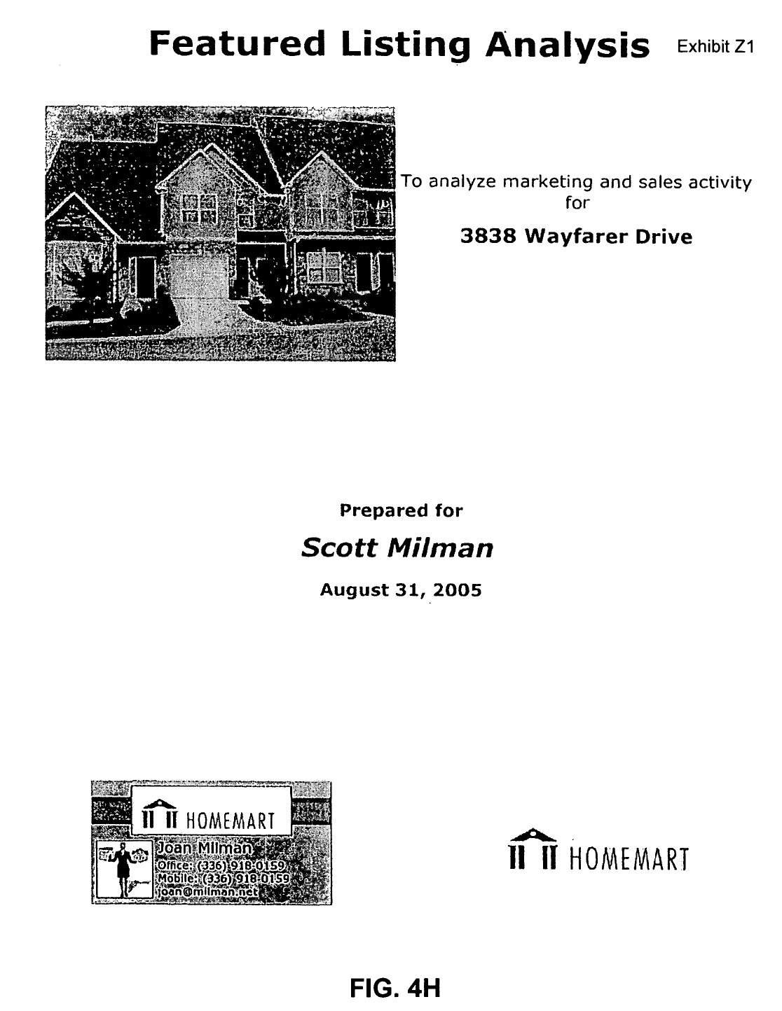

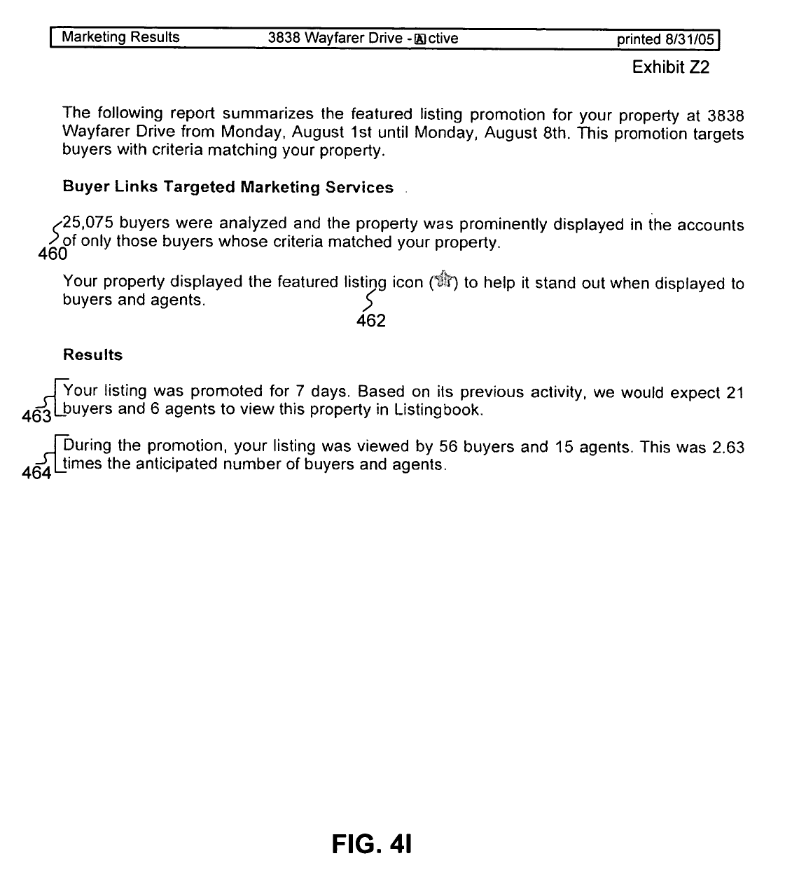

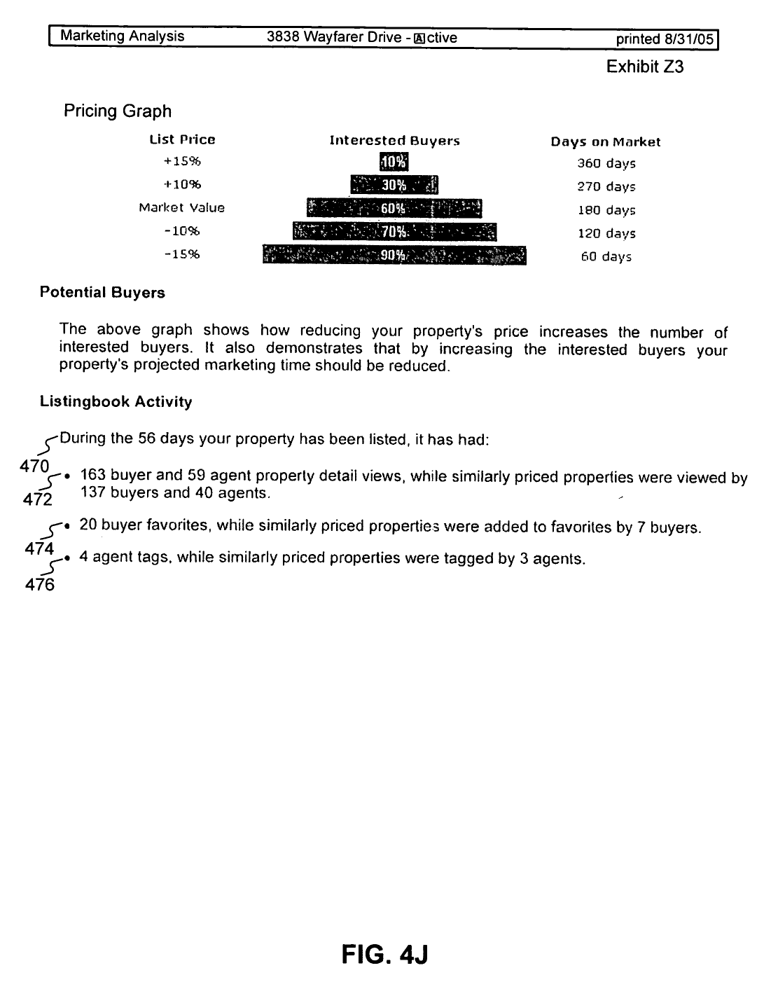

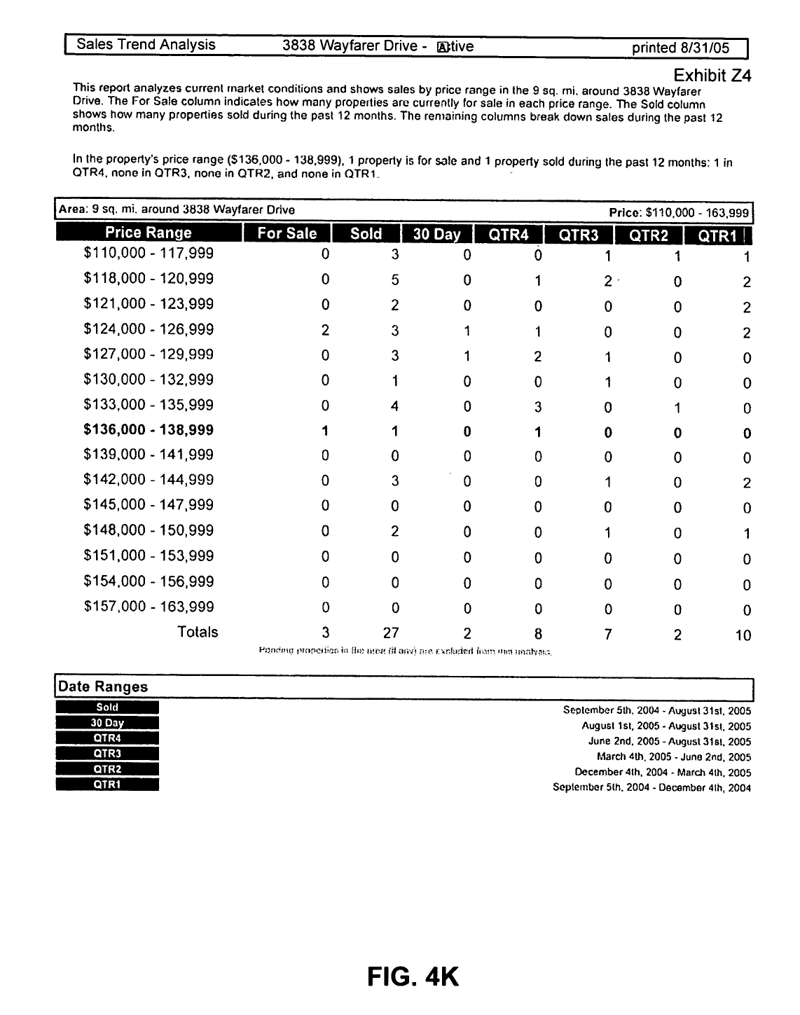

FIGS. 4A-4K are screenshots of an example of a Buyer Featured Listing (BFL) promotion, consistent with an embodiment of the present invention. An agent 103 may first select a particular property associated with the agent 103 for the FL. In the example in FIG. 4A, the agent 103 has selected the property at “8094 Oak Creek” 401 for the FL promotion. After the agent 103 chooses the property for the FL, the agent 103 may select a “duration” 404 for the FL promotion as shown in FIG. 4B. The agent may also select a “reason” 406 for the FL promotion. A list of potential reasons may be included for selection, within the system, although that is not required. By means of example only, the agent 103 can select to feature this listing for a FL promotion based on any one of the following reasons: Historic Home, Seller Financing, Lease Purchase, Acreage, Ground Floor Unit, Auction, Development Potential, Perfect for Horse Farm, Basement Lot, Waterfront Lot, Community Lot, Level Lot, Attention Builders, Grand Opening, Main Level Bedroom, Golf Course Community, Gated Community, Main Level Garage, One Level Living, Waterfront, Listing Updated, In-Law Suite, Festival of Homes, Neighborhood Pool, New Price, Back on Market, Listing Correction, Less Than Appraisal, Home Warranty, $ Towards Closing, Below Tax Value, Foreclosure, Motivated Seller, Just Listed, Must Sell, New Virtual Tour, Updated Remarks, New Photographs, or Price Reduced. Under preferred embodiments of the invention, the reason selected by the agent 103 is highlighted on the property's full photo report page when the property is viewed by a buyer 102 or agent 103.

As in the OH, the agent is given an estimation of the number of buyers having matching criteria, before the agent completes the process and pays for the BFL. After the agent has set up the FL details, a confirmation 408 is shown to the agent 103 before the FL is displayed to buyers with matching search criteria in FIG. 4C. The total number of days 410 that the listing will be featured on the system is shown to the agent 103.

Once the agent 103 has confirmed the start date and duration of the FL, the agent 103 may select one or more notifications 420 that are sent to the FL property owner as shown in FIG. 4D. The agent 103 may also select from a pull down menu 426 the name of the seller of the property that is to receive notifications. The agent 103 may select to send an announcement message 422, and/or a Featured Listing Analysis (FLA) report 424 to the seller.

Once the agent 103 has selected the one or more types of notifications to be sent, the agent 103 may then be prompted to enter payment information as shown in FIG. 4E. This payment process is the same as previously disclosed. After the agent pays for the promotion service, the process begins and notification messages are preferably sent to the seller of the property associated with the FL. FIG. 4F shows an announcement message 422 sent to the seller informing the seller of the FL. In the example on page 4F, the recipient of the FL message is “Scott Milman” 450. The announcement message informs the seller of the property that the agent 103 has promoted their property for a FL. The seller is notified that buyers and agents associated with the buyers that have key search criteria that matches the listing will be notified of the FL. The seller is also notified that the property will be marked with a “gold star,” of some other visual indicator, so that it draws attention to the listing. The seller is further notified that the listing will be at the top of the daily online listing and the buyer's morning reports.

In order for a buyer to receive information on the FL through RE manager 104, the property needs to be in a buyer's property list. That can happen if the FL matches the buyer's Home Finder criteria, or matches a search made by the buyer (Quick Search criteria), or was previously selected as a Favorite by the buyer. As discussed above, a property may appear on a buyer's home finder criteria if key search criteria of the buyer match the features of a property.

If the agent 103 chose to send a FLA report 424, then at the end of the promotion the seller is sent the message as shown in FIG. 4G explaining that the FLA report for the FL is attached to the message. FIG. 4H-4J are an exemplary FLA report for the FL promotion. The listing agent promoting the property is automatically sent the report.

The FLA report is a detailed report that summarizes the FL promotion for the selected property. The report is similar to the promotion report for an open house. For example, the report may inform the recipient of the number of buyers that were analyzed 460 to determine if they should receive information on the FL. The report may also inform the recipient that the property was displayed as a FL with a special icon 462 to help it stand out when displayed to buyers and agents. The report may also inform the recipient of the number of days the FL promotion lasted and the number of buyers and agents that viewed the FL on the system 463. The report may also inform the recipient that the listing was viewed by a certain number of agents and buyers 464.

The report preferably also informs the recipient of the activities that took place during the FL promotion. For example, the report may inform the recipient of the number of days the property was featured 470. The report may also inform the recipient of the number of buyers and agents that viewed the property details of the property, and also give a comparison of similarly priced properties that were viewed by a different number of agents and buyers 472. Viewing by buyers and/or agents may be in the form of a property detail view, where the buyer has selected the particular property and viewed the details of the property. The report may also inform the recipient of the number of buyers that listed this property as a “favorite” in their account and the number of similarly priced properties that were listed as a “favorite” 474. For example, a property can be considered similarly priced if it is within 20% of the price of the promoted property. The report may further notify the recipient of the number of agents and/or buyers who tagged the property 476, as well as comparing it with other similarly priced properties and the number of tags those properties received.

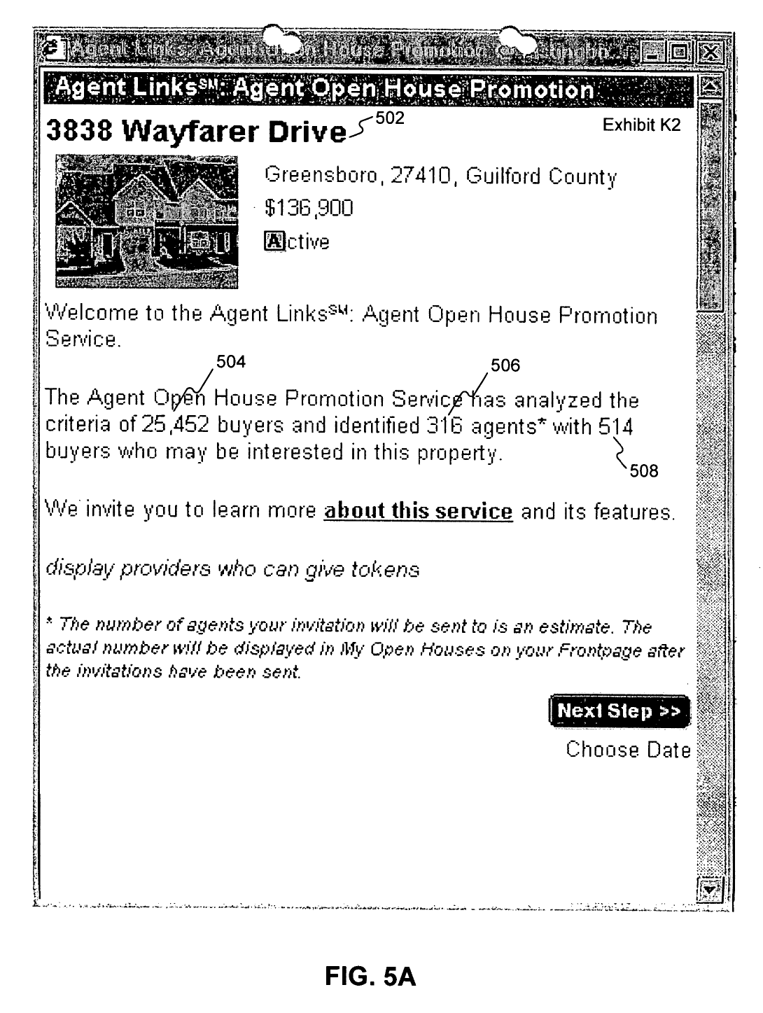

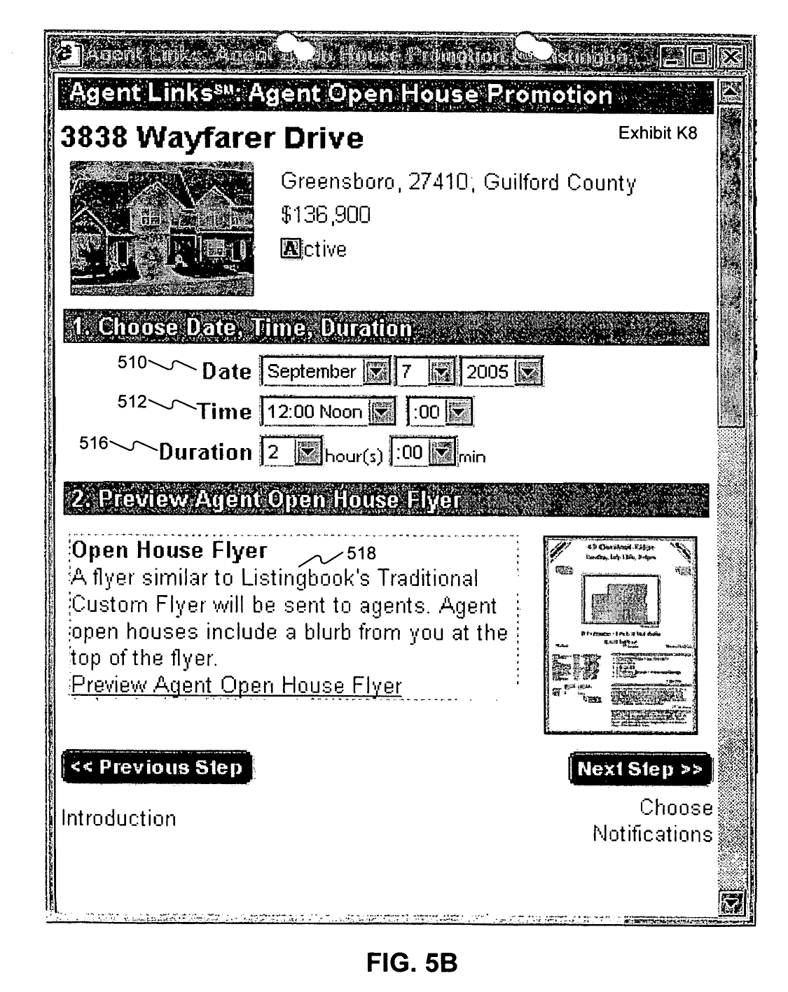

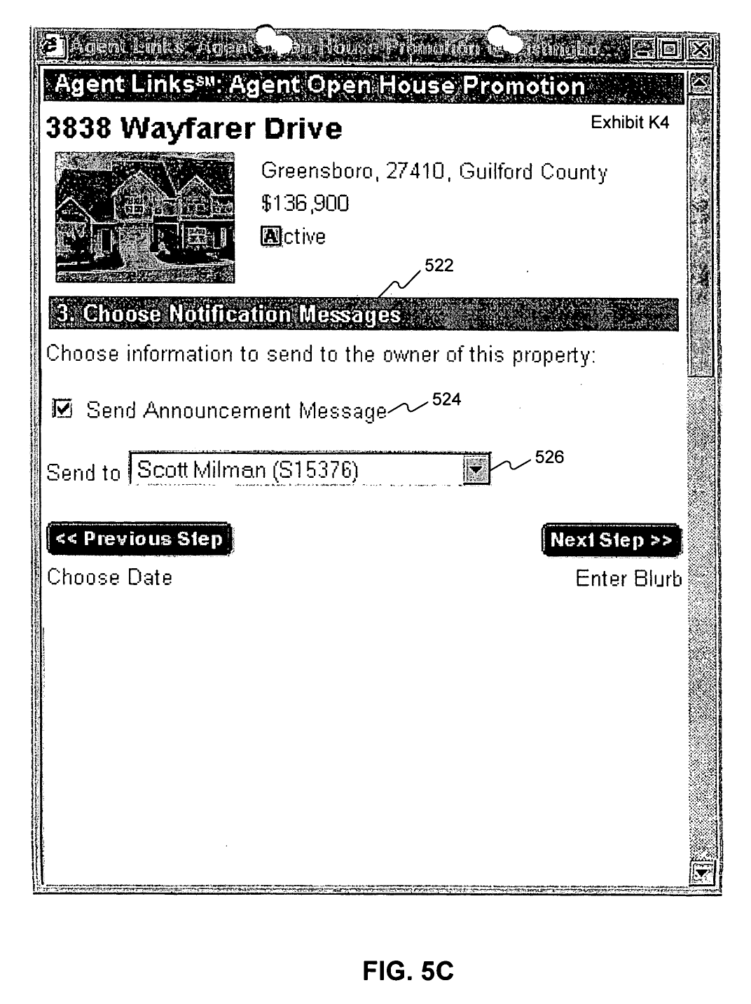

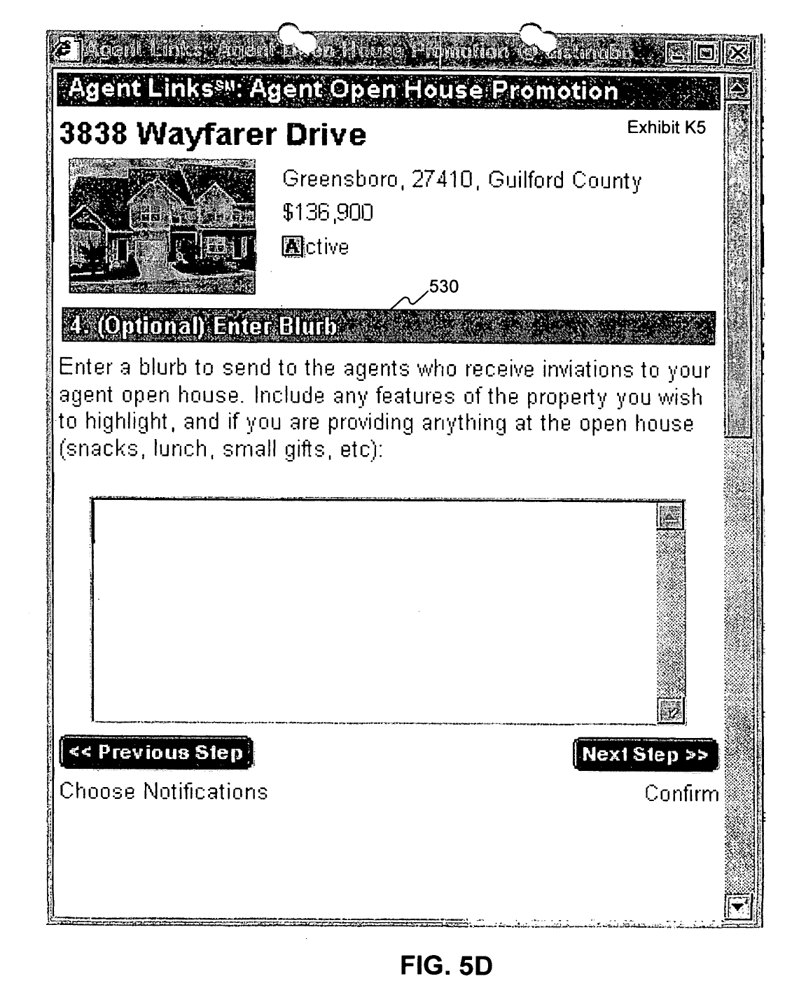

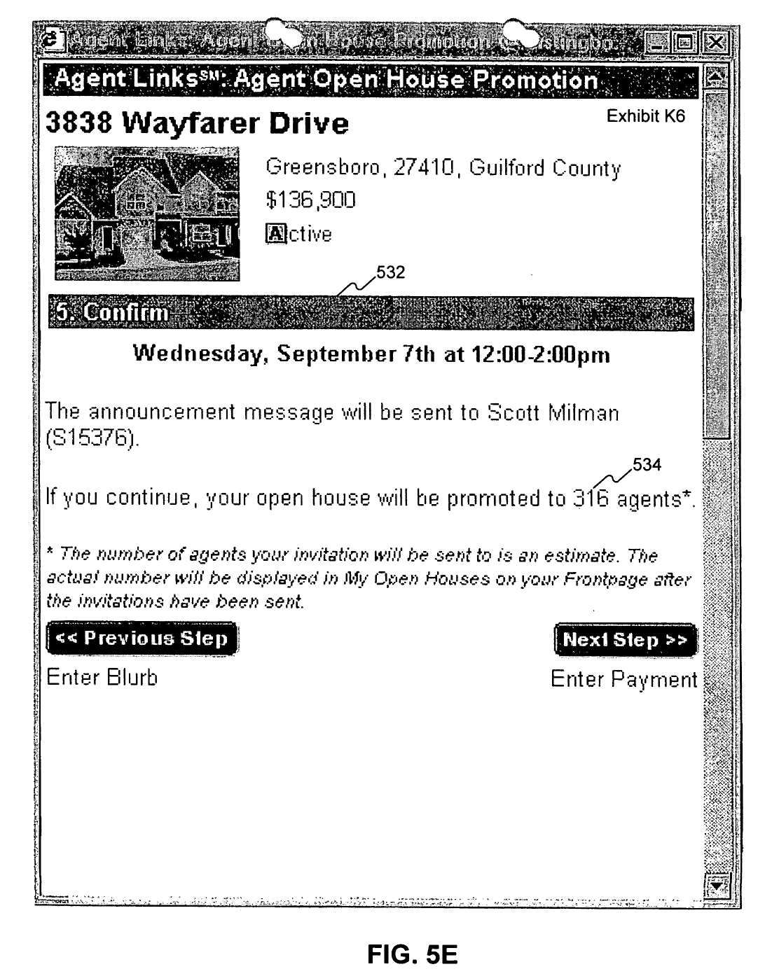

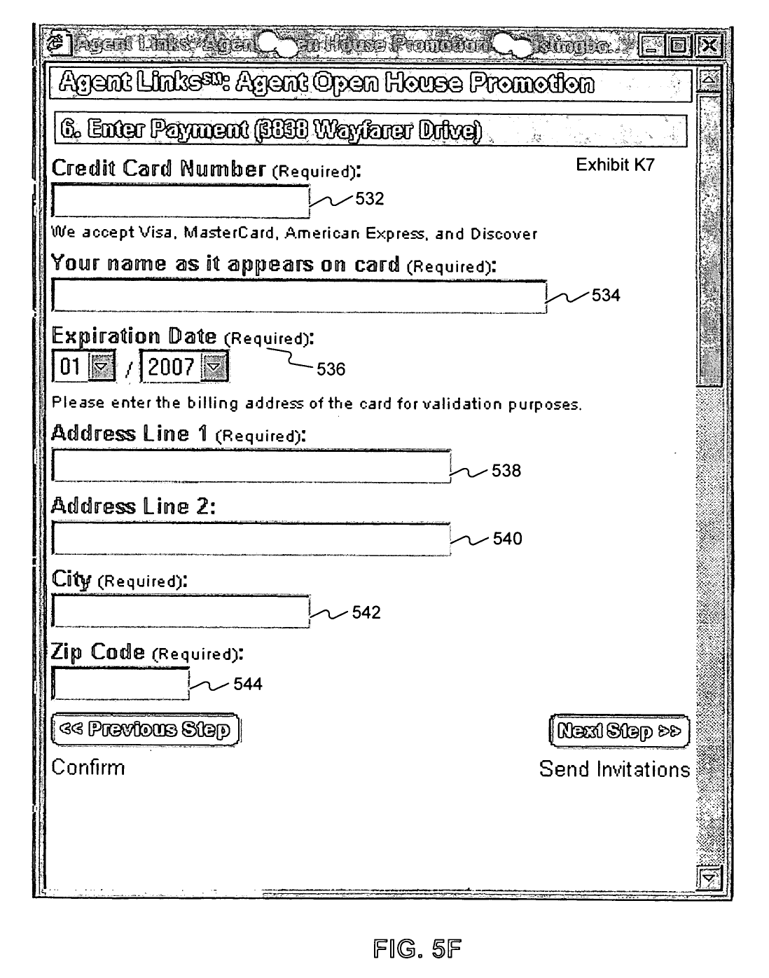

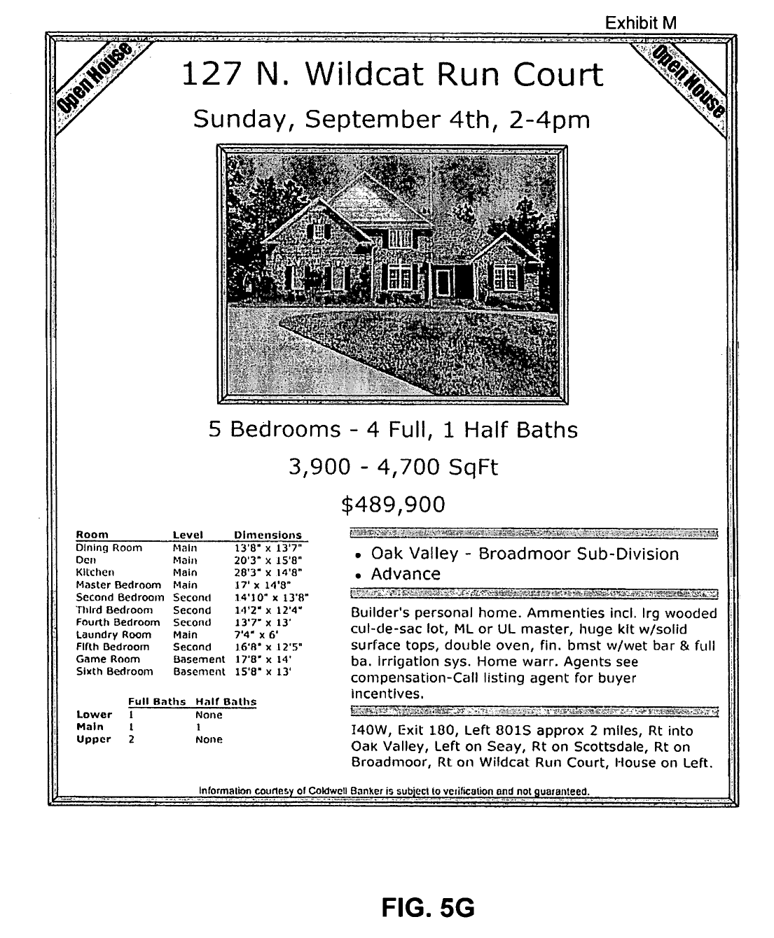

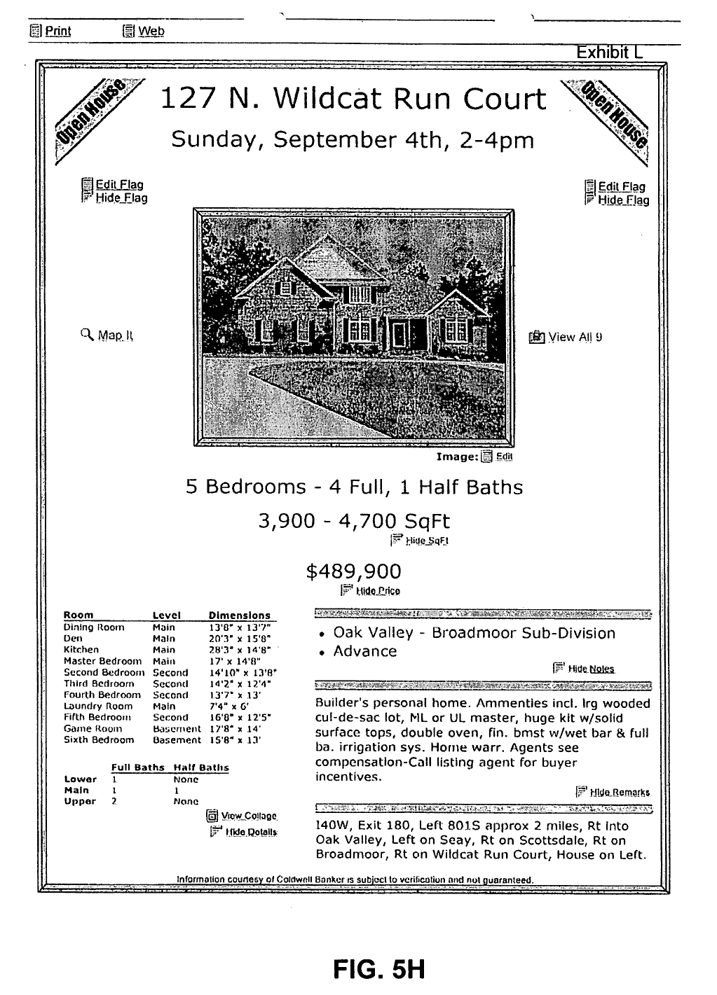

FIGS. 5A-5H are screenshots of an example of an Agent OH (AOH) promotion, consistent with an embodiment of the present invention. An AOH promotion is similar to a BOH promotion, however, only agents, and not the buyers receive this promotion. An AOH promotion therefore allows agents to consider how to best price and sell a property and to offer possible special terms and conditions between agents, to affect such a sale.

An agent may first select a particular property listed by the agent 103 for the AOH. In the example in FIG. 5A, the agent 103 has selected the property at “3838 Wayfarer Drive” 502 for the AOH promotion. After the agent 103 selects the particular property for the AOH, RE Manger 104 may analyze all the buyers' profiles in accounts database 108 to determine whether any of the buyers have key search criteria that matches the OH property. RE manager 104 may then provide the number of agents with buyers who may be interested in the property. For example, as shown in FIG. 3A, “25,452” 304 buyers' profiles were analyzed and “316” 506 agents with “514” 508 buyers were identified that may be interested in the property based on whether the OH property has features that match the key search criteria of buyers. In order for the OH to show up in the agent's Open Houses, it needs to match the key elements of the buyer's search criteria. By means of example only, the key elements can be type of property, area, price range, levels, beds, and acreage.

Agent 103 may then select a “date” 510, “time” 512, and “duration” 516 for the AOH as shown in FIG. 5B. If more than one day is needed for the open house, an additional date can be added. Once the agent 103 completes setting up the details of the AOH, the agent may then preview an OH flyer 518 that explains the details of the AOH. This flyer is created by the system from data in the system and may be viewed by all agents representing buyers that have key search criteria for a property that matches this particular property.

After setting up the AOH, the agent 103 may select one or more notifications 522 that are sent to the property owner as shown in FIG. 3D. The agent 103 may select to send an announcement message 524 to the seller of the property that is the subject of the AOH. The agent 103 may also select the name of the sellers of the property from a pull down menu 526.

Once the agent 103 has selected the one or more type of messages to be sent, the agent 103 may then optionally enter a statement or blurb 530 to be viewed on the OH flyer as shown in FIG. 5D. The agent 103 may include any features of the property they wish to highlight in this blurb. The agent 103 may also include any other pertinent information regarding the AOH, for example, whether lunch or gifts will be provided.

The agent 103 may then be presented with a confirmation 532 of the AOH as shown in FIG. 5E. If the agent 103 confirms the AOH, the agent 103 is notified of the number of agents 534 who will receive the AOH information.

The agent 103 may then be prompted to pay for the promotion, in the manner previously explained. Once the agent 103 pays for the promotion, the various notification messages are sent. FIG. 5H illustrates an OH flyer that an agent 103 can edit before sending it FIG. 5G illustrates an OH flyer that an agent receives from another agent regarding a property.

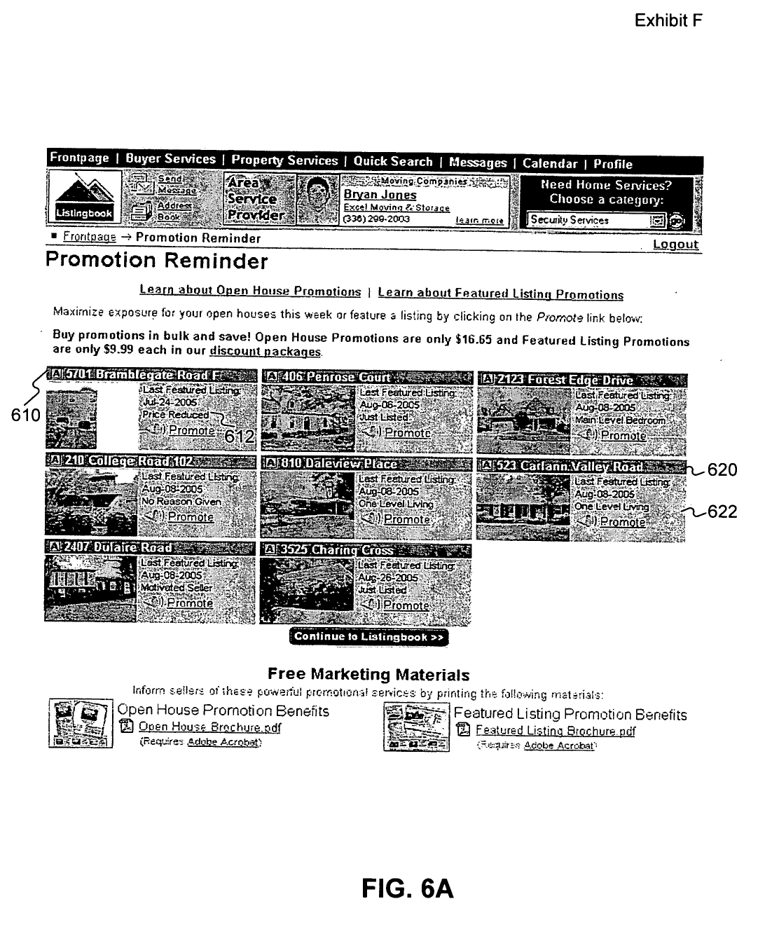

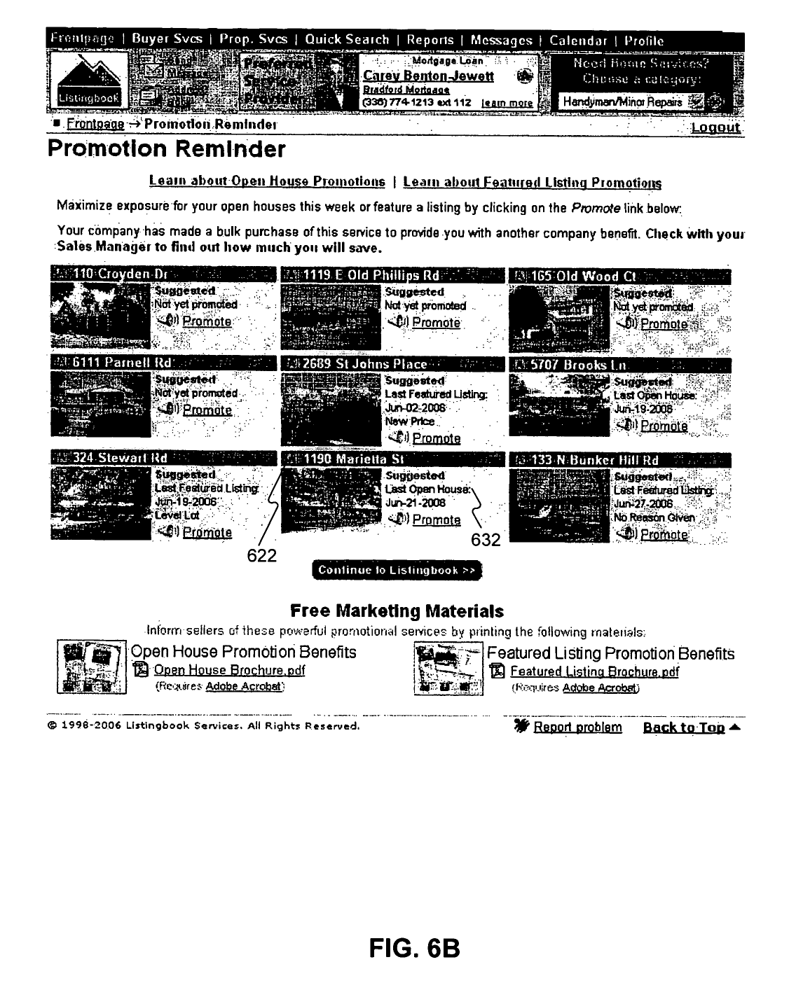

FIGS. 6A-B are screenshots of a promotion reminder splash page, consistent with an embodiment of the present invention. The promotion reminder splash page displays the properties a real estate agent has listed. When an agent 103 logs into their account, they may first see this splash page. According to a preferred embodiment of the invention, an agent 103 is notified of properties that have not been promoted, or the date a property was last promoted, and if a featured listing exists, the reason given for featuring the listing. For example, and as shown in FIG. 6a, a property 610 is promoted because the “price reduced” 612. Another example is property 620 that is promoted because of a “one Level Living room” 622. As shown in FIG. 6B, property 632 was last promoted as an OH on Jun. 21, 2006. An agent 103 may also select a property to promote from this page. This page therefore allows for an agent 103 to track their past promotional efforts and conduct new promotions. The splash page thus assists the agent in promoting his or her properties, and also serves as a form of marketing the promotional services to the agent.

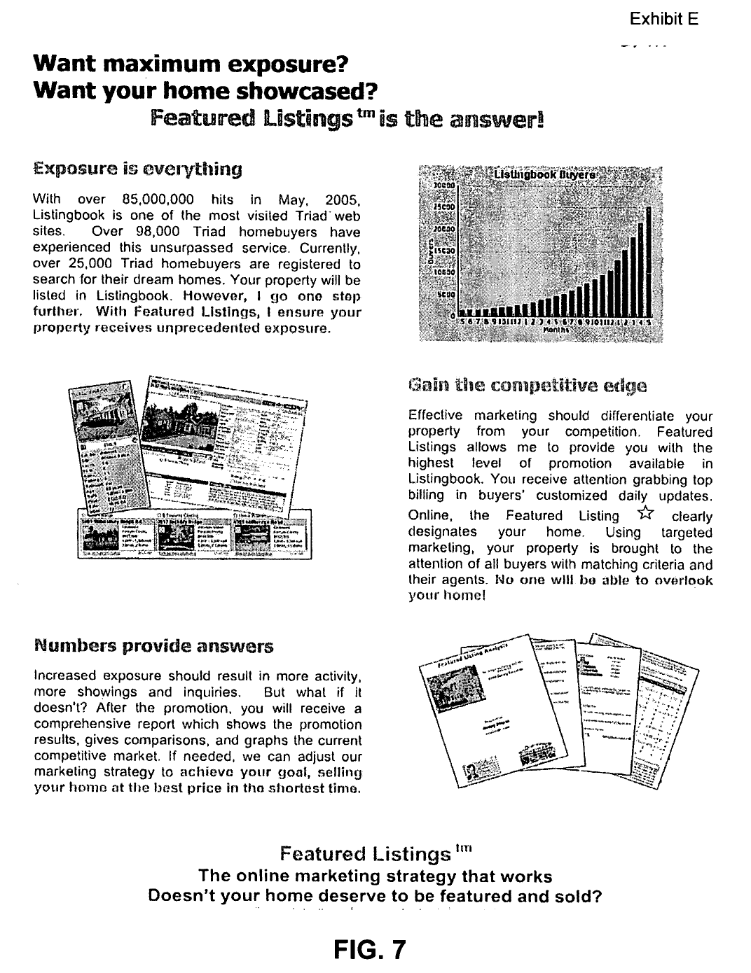

FIG. 7 is an exemplary Buyer Featured Listing brochure, consistent with an embodiment of the present invention. This brochure is available on the promotion reminder splash page (cf. FIG. 6A-B) and can be printed or emailed from RE Manager 104. This brochure may be used in marketing packages when an agent 103 makes presentations to prospective home sellers.

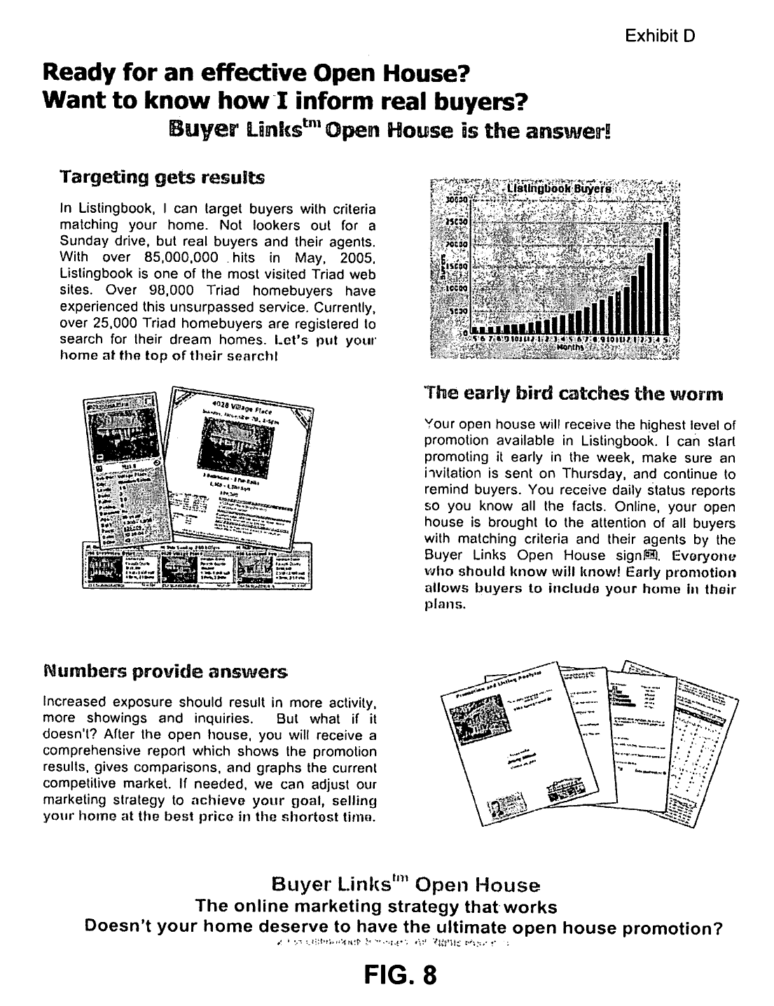

FIG. 8 is an exemplary Buyer Open house brochure, consistent with an embodiment of the present invention. This brochure is also available on the promotion reminder splash page (cf. FIG. 6A-B) and can be printed or emailed from RE Manager 104. This brochure may be used in marketing packages when an agent 103 makes presentations to prospective home sellers.

In an embodiment of the present invention, an agent 103 may be given a chance to purchase more than one promotion at a discount rate. For example, an agent can purchase a bulk set of OH promotions at a discount. .

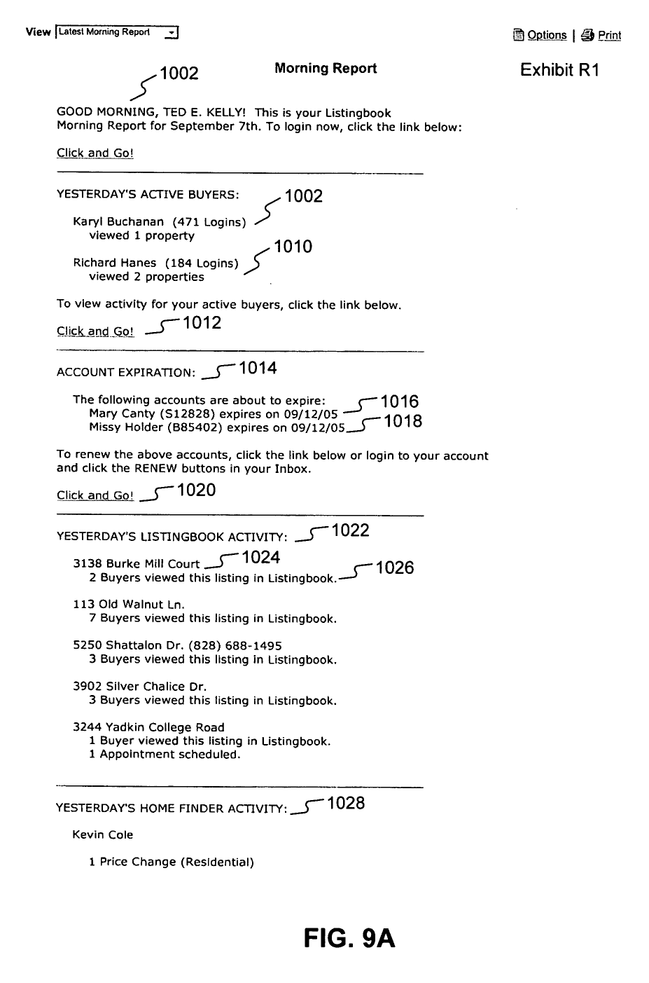

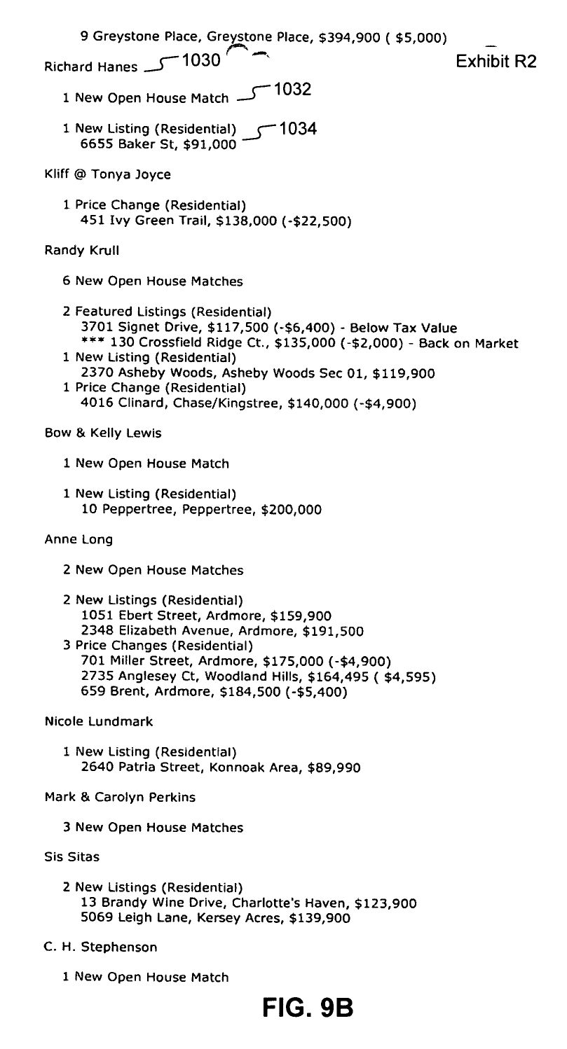

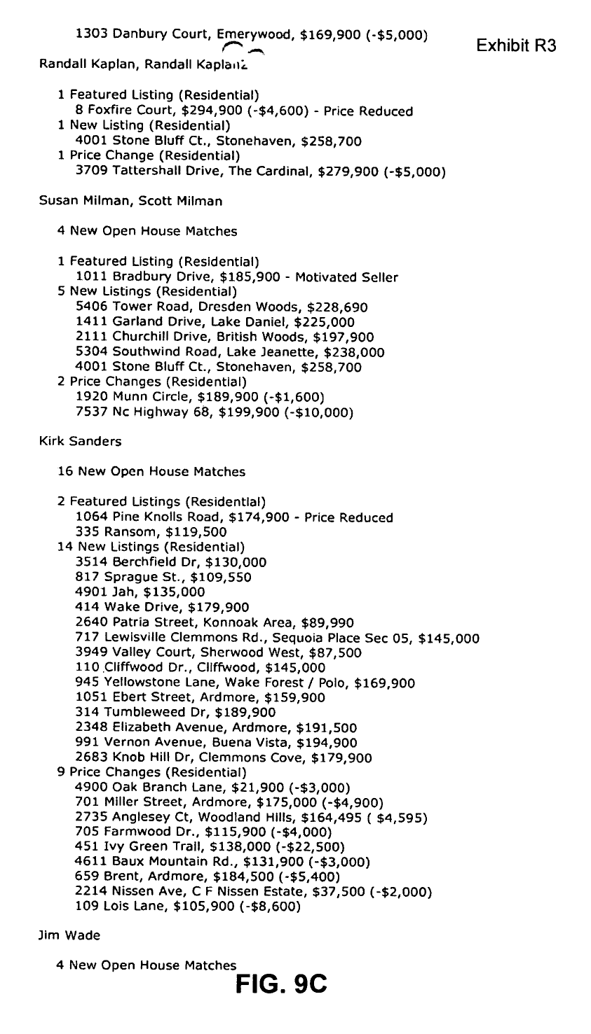

According to preferred embodiments of the invention, agents and preferably any buyers or sellers entered into the system, are provided periodic reports, preferably morning reports each day. FIGS. 9A-C are exemplary agent morning reports, consistent with an embodiment of the present invention. All agent promotions are included in a daily report (morning report) received by the agent 103 in their email and also in their account when logged into the system created by RE manager 104. RE manager 104 creates the morning reports. Each day the agent 103 can see how many new open houses match each of the buyers they represent. The agent 103 can also see specific homes being featured that match their buyers' key search criteria. If the agent 103 wants more information on any of these properties, a link if provided to obtain more detailed information.

In the morning report in FIGS. 9A-C, agent “ed Kelly” 902 is receiving the morning report. The morning report shows the previous days' activities by the particular agent's buyers. Therefore, agent “Ted Kelly” can see activities of his buyers “Karly Buchanan” 1008 and “Richard Hanes” 910. A link 912 may also be presented in the morning report that allows the agent 103 to view the activity for each buyer. The agent 103 may also be able to see which buyer accounts are going to expire 914 within a predetermined amount of time. In this example, “Ted Kelly” 902 has two accounts that are about to expire, an account for “Mary Canty” 1016 and “Missy Holder” 918. The agent 103 may also be given a chance to renew the accounts that are going to expire by clicking on a link 920 presented in the morning report.

The agent 103 may also be able to review activity from the previous day 922 associated with each property associated with the agent. For example, “Ted Kelly” 1002 can see that the property at “3138 Burke Mill Court” 914 has 2 viewings by buyers 926. The agent 103 may also be able to view the previous days' home finder activity 928. In the morning report, home finder activity is the previous day's new or changed listings that match a buyer's key search criteria. RE manager 104 may search the property data database 112 before creating the report to determine whether any new properties were added or whether any property listings were changed. If a new or changed property matches any buyer profile in accounts database 108, RE manager 104 may add this property to the home finder activity 928 section of the morning report. In the example on pages 9A-C, various home finder activity 928 is shown. For example, buyer “Richard Hanes” associated with agent “Ted Kelly” 902 has 1 new OH match 932 and 1 new listing match 934. Therefore, a new OH was added that matched “Richard Hanes” 930 profile since the last time the agent morning report was sent out and a new listing 934 was also added to the property data database 110 since the last time the agent morning report was sent.

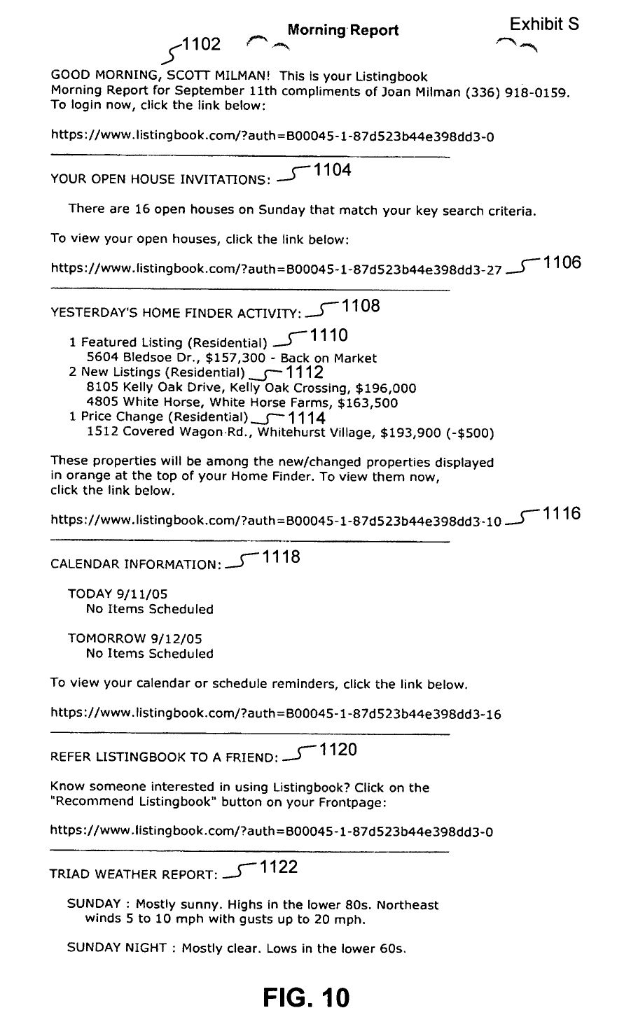

FIG.10 is an exemplary Buyer morning report, consistent with an embodiment of the present invention. The buyer promotions are included in a daily report (morning report) received by homebuyers associated with the system 100. The buyers who have accounts stored in accounts database 108 are notified in the morning report when any new open houses that meet their search criteria are added to the property data database 112. Furthermore, a cumulative update may be given on certain days of the week, for example, on a Friday, Saturday and Sunday. The buyer morning report may include links to view flyers well as more details concerning certain properties.

The buyer morning report as shown in FIG. 10 is for buyer “Scott Milman” 1002. The morning report may include any open house invitations 1104 relevant to the buyer. For example, “Scott Milman” 1002 has “16 ” open houses on Sunday that match his key search criteria. The buyer may be given a link 1106 to be able to view the property details related to each of the 16 open houses. The buyer's morning report may also include the previous day's home finder activity 1008. The home finder activity may include information on any new featured listings 1010 that were added to the accounts database 108 by any agent that match the criteria of the current buyer. The home finder 1008 activity may also include any new listings 1012 that were added to the property data database 110 that match the home search criteria of the current buyer. The home finder 1008 activity may also include any changes in property information of previous listings that match the home criteria for the buyer. For example, for “Scott Milman” 1002, a “price change” 1114 reflects this property showing up in the morning report. The buyer is also given a link 1016 to be able to view the property details relating to each of the properties listed in the home finder activity 1008 section of the morning report. The morning report may also include calendar information 1018. The calendar information may list appointments the agent 103 of the particular buyer has set up to view certain properties or any other items the user wants to enter as a scheduled calendar item or task. The morning report may further include an area for a buyer to refer the service to a friend 1020 as well as the local weather report 1022.

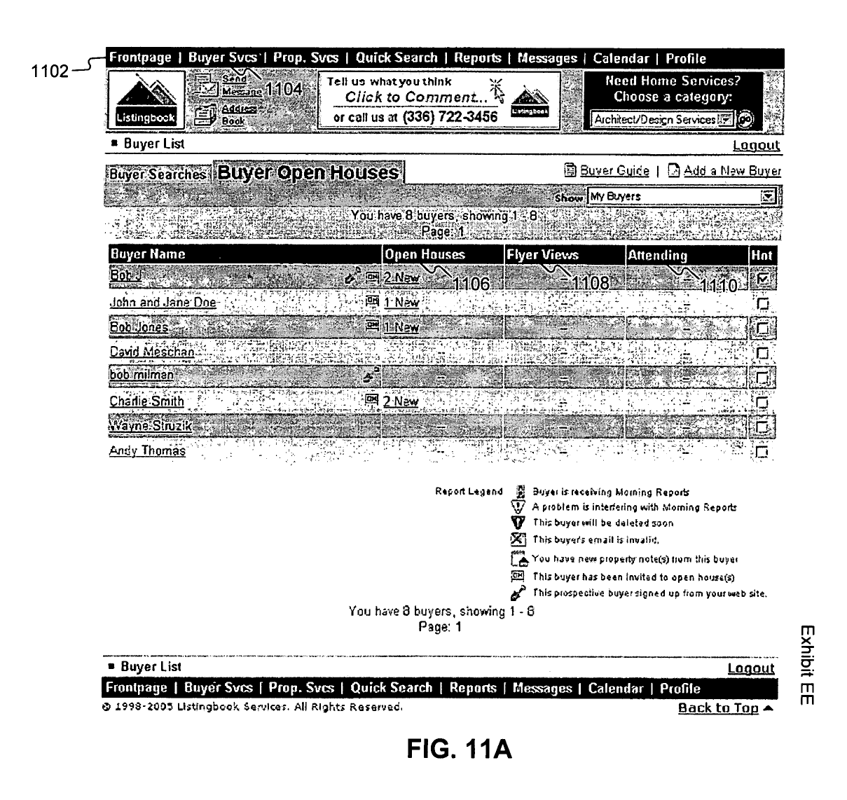

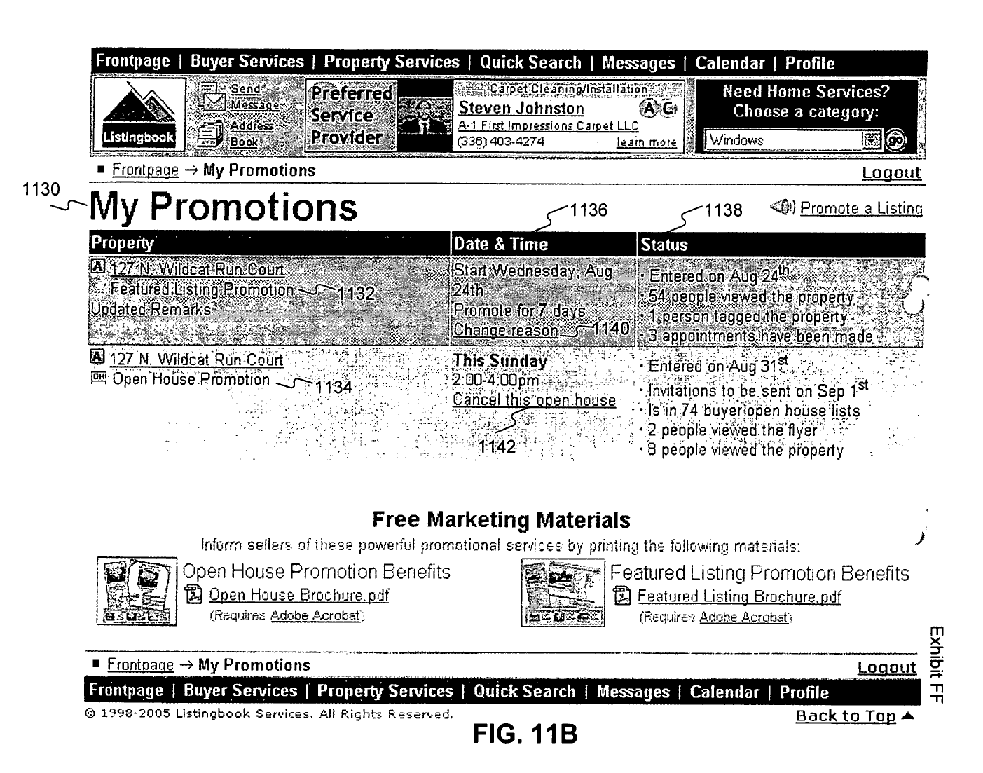

FIG. 11A and 11B is an exemplary screenshots of an Agent account, consistent with an embodiment of the present invention. When an agent logs into webpage generated by the system 104, the first page they see is the Frontpage 1102. One of the tabs in the Frontpage 1102 is “Buyer Services” 1104 that contains links to OH information specific to each of the agent's buyers. In the Buyer Services 1104 area, the OH column 1106 indicates Buyer Links open houses (if any) that match each buyer's key home finder criteria. The Flyer Views column 1108 indicates open houses that interested the buyer enough to view the OH flyer for the property. The Attending column 1110 indicates properties that interested the buyer enough after viewing the Open House Flyer to indicate they planned to attend the open house.

FIG. 11B is an exemplary screenshot of a sub-page off of the agent's Frontpage where the agent can view all their promoted listings. Under “My Promotions” 1130, the agent's OH and FL listing promotions are listed. In this example, this particular agent has one FL promotion 1132 and one OH promotion 1134. The details 1136 of each promotion are listed for each promotion as well as the status 1138 of each promotion. The agent is able to change the reason behind a featured listing 1140 as well as canceling an open house 1142 from this part of the Frontpage.

FIG. 12 is an exemplary agent listing activity report, consistent with an embodiment of the present invention. Agent promotions are kept with each property in the property data database 110 for each reference. Therefore, agents can review the progress of the promotions. Agents can compare the activity in the listing activity report such as the Last Tagged and Rated to views of the property. For example, as shown in FIG. 12, for the property at “8094 Oak Creek” 1202, the agent associated with the property can see that as a featured listing 1204, the property was listed as a featured listing for “7” days 1205, had “24” agent views 1206 instead of an expected “10 ” 1208 agent views, “111” buyer views 1210 instead of an expected “44” 1212 buyer views, and “0” agent tags 1210 instead of an expected “0” agent tags 1816.

The agent 103 can also see the details for the same property if it was listed as an Open house 1220. The agent can see the number of days “3” 1221 that the property was associated with the OH. The agent can also see the number of agents that viewed the property; in this case “14” different agents 1222 viewed the property while only 7 were expected.

The foregoing description of possible implementations consistent with the present invention does not represent a comprehensive list of all such implementations or all variations of the implementations described. The description of only some implementations should not be construed as an intent to exclude other implementations. Moreover, the systems and methods disclosed herein may be embodied in various forms including, for example, a data processor, such as a computer that also includes a database. Moreover, the above-noted features and other aspects and principles of the present invention may be implemented in various environments. Such environments and related applications may be specially constructed for performing the various processes and operations according to the invention or they may include a general purpose computer or computing platform selectively activated or reconfigured by code to provide the necessary functionality. The processes disclosed herein are not inherently related to any particular computer or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Systems and methods consistent with the present invention also include computer readable media that include program instruction or code for performing various computer-implemented operations based on the methods and processes of the invention. The media and program instructions may be those specially designed and constructed for the purposes of the invention, or they may be of the kind well known and available to those having skill in the computer software arts. Examples of program instructions include, for example, machine code, such as produced by a compiler, and files containing a high level code that can be executed by the computer using an interpreter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method of providing one or more promotions through a real estate service having access to a plurality of participants and to real estate data regarding properties, property features, participants, and participant criteria, the method comprising:
offering to one or more participants one or more property promotions that can be selected;
allowing a participant to select a promotion for a particular property to be promoted;
comparing preselected features of the particular property to be promoted with participant criteria to determine matching participants; and
sending promotional materials to the matching participants determined through the comparing step.

2. The method of claim 1, further comprising the step of tracking responses of matching participants to the selected promotion.

3. The method of claim 2, further comprising the step of sending to the participant selecting the promotion information regarding the nature and results of the promotion.

4. The method of claim 3, wherein the information regarding the nature and results of the promotion include responses of matching participants to the selected promotion during the promotion.

5. The method of claim 4, wherein the information regarding the nature and results of the include a promotion analysis report generated after the conclusion of the promotion.

6. The method of claim 2, wherein the participants include real estate agents, sellers, and buyers.

7. The method of claim 2, wherein the participants include buyers and sellers.

8. The method of claim 6, wherein the participant selecting the promotion is a real estate agent promoting the property of his or her client seller.

9. The method of claim 8, further comprising the step of sending to the seller information regarding the nature and results of the promotion.

10. The method of claim 9, wherein the information regarding the nature and results of the promotion include a preliminary announcement notifying the seller of the promotion and periodic notices identifying the responses of matching participants to the promotion.

11. The method of claim 2, wherein the participant criteria includes buyer desired property criteria indicating property features a buyer desires and wherein the matching participants include all participating buyers who have desired property criteria that match with the preselected features of the property being promoted.

12. The method of claim 11, wherein the matching participants also include all participating agents having client buyers who have desired property criteria that match with the preselected features of the property being promoted.

13. The method of claim 2, wherein the participant criteria includes buyer desired property criteria indicating property features a buyer desires and wherein the matching participants include only participating agents having client buyers who have desired property criteria that match with the preselected features of thy property being promoted.

14. The method of claim 1, further comprising the step of allowing the participant selecting the promotion to define specific characteristics of the promotion.

15. The method of claim 14, wherein the defined specific characteristics of the promotion include the type of promotion and the timing of the promotion.

16. The method of claim 15, wherein the defined specific characteristics further include a message created by the selecting participant to be included as part of the promotion.

17. The method of claim 1, wherein the preselected features of the particular property include the price of the property and its geographical location.

18. The method of claim 17, wherein the preselected features of the particular property further include the property type and the numbers of bedrooms and bathrooms.

19. The method of claim 2, further comprising the step of periodically sending each participating agent a morning report, wherein the morning report summarizes activity of each property associated with the agent and further identifies pending promotions and recent responses to the promotions.

20. The method of claim 11, further comprising the step of periodically sending each participating buyer a morning report and wherein the morning report includes promotional information of then active promotions that match with the desired property criteria of the buyer.

21. The method of claim 1, wherein the real estate system includes a server and each participant has an account and further comprising providing a webpage for each participant to allow the recipient to access his account.

22. The method of claim 21, wherein the participants can access the server and send or receive information regarding promotions at their convenience.

23. The method of claim 21, wherein the participants can access the server through the internet.

24. The method of claim 2, wherein the real estate system allows matching participants to view the property being promoted and further comprising the steps of tracking matching participants' views of the promoted property and providing such tracked information to the participant selecting the promotion.

25. The method of claim 2, wherein the real estate system allows matching participants to tag the property being promoted as of potential interest and further comprising the steps of tracking matching participants' tagging of the promoted property and providing such tracked information to the participant selecting the promotion.

26. The method of claim 2, wherein the real estate system allows matching participants to identify the property being promoted as a favorite and further comprising the steps of tracking matching participants' identification of the promoted property as a favorite and providing that information to the participant selecting the promotion.

27. The method of claim 1, further comprising the step of charging for the promotion, but only after first providing an estimate of the matching participants who would receive the promotion, determined by comparing preselected features of the property to be promoted with participant criteria in the real estate data.

28. The method of claim 1, further comprising the step of sending one or more notifications to one or more sellers associated with the particular property.

29. The method of claim 28, wherein the one or more notifications include an announcement message and summary report.

30. The method of claim 28, the wherein the one or more notifications include an announcement message, an invitation, and a summary report.

31. The method of claim 1, further comprising the step of sending a summary report to the participant selecting the promotion and wherein the summary report includes the number of participants analyzed to determine if they should receive the promotion, and the number of participants that received the promotion.

32. The method of claim 31, wherein the summary report includes the number of buyers analyzed to determine if they should receive the promotion, and the number of buyers that received the promotion.

33. The method of claim 1, wherein the one or more promotions are selected from the group consisting of a featured listing promotion, a buyer open house promotion, or an agent open house, wherein the promotion is associated with a property that is for sale.

34. The method of claim 33, wherein the promotion is a buyer open house promotion and wherein the selecting participant selects the time and place for an open house open to buyers and agents of buyers and wherein the matching participants are notified of the open house, provided with a view and information regarding the property being promoted, and are periodically reminded of the open house.

35. The method of claim 34, wherein the participant selecting the promotion is provided with a promotion listing report that indicates the number of participants analyzed in the comparing step, the number of matching participants who received a notification of the open house, and the number of participants who reviewed the promoted property during the promotion.

36. The method of claim 33, wherein the promotion is an agent open house promotion, the selecting participant selects the time and place for an open house open to agents only, the matching participants are agents, and wherein the matching agent participants are notified of the open house, provided with a view and information regarding the property being promoted, and are periodically reminded of the open house.

37. The method of claim 36, wherein the matching agent participants also receive a message created by the selecting participant about the agent open house and any information the selecting participant desires to tell the matching agents.

38. The method of claim 33, wherein the promotion is a featured listing promotion and wherein the selecting participant defines the nature of the feature being promoted and the time period of the promotion and wherein the matching participants receive notices of the promoted property and feature during the promotion period.

39. The method of claim 38, wherein properties being promoted are identified by a visual identification symbol that is part of the promotional materials and wherein the properties be promoted are placed in a priority position, when the matching participants view listings or other information provided during the promotion.

40. A computer-implemented method of providing one or more promotions through a real estate service having access to a plurality of participants and to real estate data regarding properties, property features, participants, and participant criteria, the method comprising:
offering to one or more participants one or more property promotions that can be selected;
allowing a participant to select a promotion for a particular property to be promoted;
comparing preselected features of the particular property to be promoted with participant criteria to determine matching participants;
sending promotional materials to the matching participants determined through the comparing step;
tracking responses of matching participants to the selected promotion; and
providing the participant selecting the promotion with information associated with the responses of matching participants to the promotion.

41. The method of claim 40, further comprising the step of allowing the participant selecting the promotion to define specific characteristics of the promotion.

42. The method of claim 41, further comprising the steps of charging the promotion, but only after first providing an estimate of the matching participants who would receive the promotion, determined by comparing preselected features of the property to be promoted with participant criteria in the real estate data.

43. A system for providing one or more promotions through a real estate service having access to a plurality of participants and to real estate data regarding properties, property features, participants, and participant criteria, the system comprising:
a processor; and
a memory,
wherein the processor and the memory are configured to perform a method comprising: offering to one or more participants one or more property promotions that can be selected;
allowing a participant to select a promotion for a particular property to be promoted;
comparing preselected features of the particular property to be promoted with participant criteria to determine matching participants;
sending promotional materials to the matching participants determined through the comparing step;
tracking responses of matching participants to the selected promotion; and
providing the participant selecting the promotion with information associated with the responses of matching participants to the promotion.
